(19) United States
(12) Patent Application Publication
(10) Pub. No.: US 2012/0231385 A1
(43) Pub. Date: Sep. 13, 2012

(54) ELECTROPHOTOGRAPHIC TONER SET

(75) Inventors: Keigo Tamaki, Machida-shi (JP); Kimihiko Ookubo, Hachioji-shi (JP)

(73) Assignee: Konica Minolta Business Technologies, Inc., Tokyo (JP)

(21) Appl. No.: 13/510,138

(22) PCT Filed: Nov. 9, 2010
(86) PCT No.: PCT/JP2010/069909

§ 371 Date: May 16, 2012

(30) Foreign Application Priority Data
Nov. 20, 2009 (JP) 2009-264693

(51) Int. Cl. G03G 9/09

(52) U.S. Cl. 430/107.1

(57) ABSTRACT

An electrophotographic toner set which is excellent in color reproduction of low lightness regions to high lightness regions in an intermediate color region (red) is disclosed, comprising at least a yellow toner, a magenta toner and a third electrophotographic toner, wherein, in a color specification system of a CIE LAB color space, a lightness L* of the magenta toner is within a range of 35-50, a lightness L* and a hue angle h of the third electrophotographic toner is within a range of 50-65 and 0-65°, respectively, and a difference in hue angle between a color represented by the yellow toner and a color represented by the magenta toner is within a range of 114-130°.

### CROSS REFERENCE TO RELATED APPLICATIONS

This is a U.S. national stage of application No. PCT/JP2010/069909, filed on 9 Nov. 2010. Priority under 35 U.S.C. §119(a) and 35 U.S.C. §365(b) is claimed from Japanese Application No. 2009-264693, filed 20 Nov. 2009, the disclosure of which are also incorporated herein by reference.

### TECHNICAL FIELD

The present invention relates to an electrophotographic toner set and in particular to an electrophotographic toner set which is excellent in color reproducibility from the low lightness part to the high lightness part in an intermediate color region (red).

### TECHNICAL BACKGROUND

In recent years, there was achieved the practical use of a color copying method in which a photoreceptor is exposed to dispersed light to form electrostatic latent images of a manuscript thereon, the latent images are developed with the individual color toners to obtain a colored copy image, or copy images of the individual colors are superimposed to obtain a full-color copy image; further, there were produced color toners of yellow, magenta, cyan and the like, in which colorants of the individual colors are each dispersed in a binder resin.

Along with the wide spread of color copying apparatuses, the variety of their uses have broadened to a wider variety and requirements for their image quality became more demanding. In copying of common photographs, a catalog or a map, extremely precise and faithful reproduction is required, including detailed portions. Accordingly, requirement for colorfulness has increased and it is desired to expand the color-reproducible range. Specifically, advances in the field of printing has recently been marked and highly precise quality equivalent to or higher than printing quality has been required.

Further, demands for printing images on a display device have rapidly increased in image processing of images on a CRT display or a liquid crystal display, in sending a manuscript to a printer through electronic data, or fom personal use; and there has been required a toner set which is capable of achieving superior correspondence to sRGB, as a standard color space in the said field (for example, “Multimedia Systems and Equipment-Color Measurement and Management-Part 2-1: Color Management-Default RGB Colour Space-sRGB” IEC, refer to 61966-2-1) and exhibiting enhanced color reproducibility.

However, the reproducible color gamut is limited in color reproduction by the four color toners of yellow, magenta and cyan as the three primary colors used in common printing and black. Specifically, in the case of presenting the intermediate color region (red, blue and green), it was difficult to realize a broad color reproduction range from low lightness regions to high lightness regions.

To overcome such a problem, Patent Document 1 discloses a full-color toner kit in which, in addition to the four toners of yellow, magenta, cyan and black, a toner of a special color (orange toner, green toner) is further added and addition of a special color which exhibits, in a color space, a color angle falling within an intermediate area of the three primary colors of printing achieves an expansion of the color reproduction area. However, only addition of a special color exhibiting an appropriate color angle is insufficient to realize the broad color reproduction range from a low lightness region to a high lightness region.

Patent Document 2 discloses an image forming method by using a third recording agent (such as a recording agent of orange) exhibiting a higher lightness than the lightness of orange or red which is formed by the combination of a yellow recording agent and a magenta recording agent, and the use of a special color recording agent of enhanced lightness realizes a broader color reproduction range from a low lightness portion of a red region to a high lightness portion.

However, this technical information is limited to a relatively narrow range in which the color angle difference in CIE LAB color space of a color specification system is 60 to 113° (degree). Accordingly, it is seen as fit for expansion of a red region but is not suitable for enhancement of the overall color reproducibility including blue and green regions.

### PRIOR ART DOCUMENT

### Patent Document

Patent Document 1: JP 2008-158151 A
Patent Document 2: JP 2005-088581 A

### SUMMARY OF THE INVENTION

### Problems to be Solved

The present invention has come into being in light of the foregoing problems and circumstances and the problems to be solved are to provide a set of electrophotographic toners which is excellent in color reproduction of low lightness regions to high lightness regions in an intermediate color region (red).

### Means for Solving the Problems

The foregoing problems related to the present invention can be by the following constitution.

1. An electrophotographic toner set comprising at least a yellow toner, a magenta toner and a third electrophotographic toner, wherein, in a color specification system of a CIE LAB color space, a lightness L* of the magenta toner is within a range of 35-50, a lightness L* and a hue angle h of the third electrophotographic toner is within a range of 50-65 and 0-65°, respectively, and a difference in hue angle between a color represented by the yellow toner and a color represented by the magenta toner is within a range of 114-130°.

2. The electrophotographic toner set, as described in the foregoing 1, wherein the third electrophotographic toner exhibits a hue angle within a range of 0-45°.

3. The electrophotographic toner set, as described in the foregoing 1 or 2, wherein the third electrophotographic toner contains a compound represented by the following formula (1):

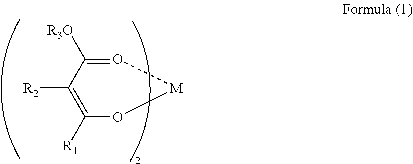

wherein M is a divalent metal ion, R₁ is a hydrogen atom or a substituent, R₂ is a hydrogen atom, an alkyl group, an alkenyl group, an alkynyl group, an aryl group, a heterocyclic group, an alkoxycarbonyl group, an aryloxycarbonyl group, a sulfamoyl group, a sulfinyl group, an alkylsulfonyl group, an arylsulfonyl group, or a cyano group, and R₃ is a hydrogen atom, an alkyl group, an alkenyl group, an alkynyl group, an aryl group or a heterocyclic group.

### Effects of the Invention

According to the foregoing means of the present invention, there can be provided an electrophotographic toner set which is excellent in color reproduction quality of from a low lightness region to a high lightness region in an intermediate color region (red).

### EMBODIMENTS OF THE INVENTION

The electrophotographic toner set of the present invention is one which comprises at least a yellow toner, a magenta toner and a third electrophotographic toner, and in which, in a color specification system of a CIE LAB color space, the lightness L* of the magenta toner is within a range of 35 to 50, the third electrophotographic toner exhibits a lightness L* of 50 to 65 and a hue angle of 0 to 65°, and the difference in hue angle between a color represented by the yellow toner and a color represented by the magenta toner is within the range of 114 to 130°. This feature is the one that is common to the invention related to the foregoing 1 to 3.

In one of the embodiments of the present invention, the hue angle of the third electrophotographic toner is preferably within the range of 0 to 45° to achieve the effects of the invention. Further, the third electrophotographic toner preferably contains the compound represented by the foregoing formula (1).

Hereinafter, there will be detailed the present invention and its constituent elements and embodiments. In the present invention, the symbol, “−” is used, which designates to include numerical values described back and forth as an upper limit value and a lower limit value.

### Electrophotographic Toner Set:

An electrophotographic toner set related to the present invention is constituted of at least a yellow toner, a magenta toner and a third electrophotographic toner.

In cases when performing color reproduction with conventional four color toners of yellow, magenta, cyan and black, a red region as an intermediate color is represented by the combination of a yellow toner and a magenta toner. However, when representing the red region only with a yellow toner and a magenta toner, it is difficult to complement a color reproduction region exhibiting a higher lightness than the color reproduction region represented by the combination of the yellow toner and the magenta toner. Accordingly, to perform sufficient expansion of a color reproduction region of the red region, it is effective to add a third electrophotographic toner exhibiting a high lightness as well as a high chroma.

The first aspect of the present invention is that a third electrophotographic toner is used in combination with a yellow toner and a magenta toner and the magenta toner exhibits a lightness L falling within a range of 35-50 in the CIE LAB color space and the third electrophotographic toner exhibits a lightness L falling within a range of 50-65.

The combination of the yellow toner and the magenta toner complements color reproduction of the red area in a low lightness region. On the other hand, the combination of the yellow toner and the third electrophotographic toner makes it feasible to expand color reproducibility of the red area in a low lightness region which is difficult to be supplemented by the combination of the yellow toner and the magenta toner.

The lightness and hue angle in a color specification system of a CIE LAB color space can be determined by spectroscopic analysis of a monochromatic toner image exhibiting a density of 2 at the wavelength of the maximum absorption peak. Such spectroscopic analysis can be carried out by using a commercially available spectrocolorimeter, for example, a spectrocolorimeter CM-508d, produced by Konica Minolta Opto, Inc.

There are usable, as a base material to form a monochromatic toner image, any one of paper (plain paper, coated paper), a white substrate such as plastic sheet, a transparent substrate such as OHP which are generally used in electrophotography. Of these, a white substrate is preferred, a white substrate which exhibits an L* value of not less than 80 and a C* value of not more than 15 in a color specification system of a CIE LAB color space is more preferred, and a white substrate which exhibits an L* value of not less than 90 and a C* value of not more than 7 is still more preferred.

The colorant content of the electrophotographic toner of the present invention is within a range of 1 to 20% by mass, based on the total mass of solids, and the coverage on the substrate is within a range of 0.1 to 10 g/m².

The second aspect of the present invention is that a difference in hue angle in a color specification system of a CIE LAB color space, between a color represented by a yellow toner and a color, represented by a magenta toner is within a range of from 114 to 130°.

It was necessary to add a reddish yellow toner to expand the region of color reproduction in a red area. In the present invention, however, the third electrophotographic toner is used in combination with a yellow toner and a magenta toner, enabling an achievement of sufficient color reproducibility in the red area. Accordingly, it becomes unnecessary to add such a reddish yellow toner and it becomes feasible to use a yellow toner exhibiting the color of yellow itself, enabling to expand the color region of a green area. Further the use of a magenta toner exhibiting more bluish magenta toner than a conventional magenta toner enables an expansion of the color region of a blue area.

Therefore, the use of a yellow toner exhibiting a color tone of intrinsic yellow or a magenta toner which is more bluish than conventional magenta toners enables an expansion of the whole color reproduction region including not only a red area but also blue and green areas.

However, in cases where the foregoing difference in hue exceeds 130°, it becomes difficult to represent color of an intrinsic yellow toner or an intrinsic magenta toner.

Hereinafter, there will be specifically described electrophotographic toners which are usable in the present invention.

### Yellow Toner:

A yellow toner usable in the present invention can use commonly known yellow toners. For effective employment of the present invention, in cases when forming a monochromatic toner image with a yellow toner, a hue angle (h) of the image in a CIE LAB color space falls preferably within a range of 85°≦h≦115°, and more preferably 90°≦h≦115°, provided that the difference in hue angle in a CIE LAB color space between a color represented by a yellow toner and a color represented by a magenta toner is within a range of 114 to 130°.

Next, there will be described yellow colorants which are preferably used in the present invention.

A yellow colorant is a dye which is capable of exhibiting a yellow color when preparing an electrophotographic toner containing the colorant and forming an image with the toner. The said colorant may be a dye or a pigment.

Specific examples of such a yellow colorant include C.I. Pigment Yellow 74, C.I. Pigment Yellow 97, C.I. Pigment Yellow 98, C.I. Pigment Yellow 111, C.I. Pigment Yellow 61, C.I. Pigment Yellow 168, C.I. Pigment Yellow 100, C.I. Pigment Yellow 190, C.I. Pigment Yellow 151, C.I. Pigment Yellow 154, C.I. Pigment Yellow 175, C.I. Pigment Yellow 180, C.I. Pigment Yellow 194, C.I. Pigment Yellow 93, C.I. Pigment Yellow 94, C.I. Pigment Yellow 128, C.I. Pigment Yellow 166, C.I. Pigment Yellow 109, C.I. Pigment Yellow 110, C.I. Pigment Yellow 173, C.I. Pigment Yellow 185, C.I. Pigment Yellow 150, C.I. Pigment Yellow 117, C.I. Pigment Yellow 129, C.I. Pigment Yellow 153 and the like.

The use of the foregoing yellow toners make it feasible to form an image exhibiting color of true yellow.

### Magenta Toner:

A magenta toner usable in the present invention can use commonly known magenta toners. In cases when forming a monochromatic toner image with a magenta toner, the lightness of the image falls within a range of 35 to 50 in a CIE LAB color space. For effective employment of the present invention, a hue angle (h) of the image falls preferably within a range of 330°≦h≦360°, and more preferably 330°≦h≦345°, provided that the difference in hue angle in a CIE LAB color space between a color represented by a yellow toner and a color represented by a magenta toner falls within a range of 114 to 130°.

Next, there will be described magenta colorants which are preferably used in the present invention.

A magenta colorant is a dye which is capable of exhibiting a magenta color when preparing an electrophotographic toner containing the colorant and forming an image with the toner. The said colorant may be a dye or a pigment.

Specific examples of such a magenta colorant include C.I. Pigment Red 58:2, C.I. Pigment Red 200, C.I. Pigment Red 7, C.I. Pigment Red 8, C.I. Pigment Red 13, C.I. Pigment Red 23, C.I. Pigment Red 223, C.I. Pigment Red 212, C.I. Pigment Red 213, C.I. Pigment Red 222, C.I. Pigment Red 238, C.I. Pigment Red 245, C.I. Pigment Red 49:2, C.I. Pigment Red 175, C.I. Pigment Red 144, C.I. Pigment Red 214, C.I. Pigment Red 220, C.I. Pigment Red 221, C.I. Pigment Red 190, C.I. Pigment Red 224, C.I. Pigment Red 202, C.I. Pigment Red 88, C.I. Pigment Red 181 and the like.

The foregoing colorants exhibit a tendency of being more bluish color, compared to those which were used in the prior art. Accordingly, the use of the foregoing magenta toners make it feasible to form an image exhibiting color of true magenta.

### Third Electrophotographic Toner:

A third electrophotographic toner usable in the present invention can use commonly known magenta toners or red toners. In cases when forming a monochromatic toner image with such a toner, the lightness of the image falls within a range of 50 to 65 in a CIE LAB color space. For effective employment of the present invention, the hue angle (h) of the image falls preferably within a range of 0°≦h≦65°, and more preferably 0°≦h≦45°.

Next, there will be described third colorants which are preferable in the present invention.

A colorant of the third toner is a dye which is capable of exhibiting a magenta or red color when preparing an electrophotographic toner containing the colorant and forming an image with the toner. The said colorant may be a dye or a pigment.

Specific examples of a pigment include C.I. Pigment Red 48:3, C.I. Pigment Red 57:1, C.I. Pigment Red 146, C.I. Pigment Red 147, C.I. Pigment Red 149, C.I. Pigment Red 170, C.I. Pigment Red 176, C.I. Pigment Red 184, C.I. Pigment Red 185, C.I. Pigment Red 187, C.I. Pigment Red 209, C.I. Pigment Red 210, C.I. Pigment Red 238, C.I. Pigment Red 254, C.I. Pigment Red 264, C.I. Pigment Red 266, Pigment Violet 19γB and Pigment Violet 19γY.

There are preferably used, as a dye, a metal chelate dye and it is specifically preferred to contain a metal-containing compound represented by the following formula (1), as described in JP 2007-034264 A.

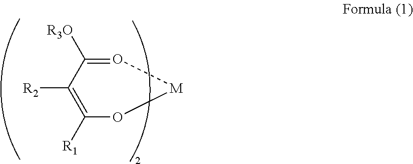

In the formula (1), M is a divalent metal ion, and preferably is a divalent transition metal ion. Of divalent transition metal ions, nickel, copper and zinc ions are preferred in terms of the color of a metal containing compound and the color of a chelated dye, and copper ion is more preferred. The metal-containing compound used in the present invention may contain a neutral ligand depending on a center metal and typical examples of such a ligand include H₂O and NH₃.

The metal-containing compound used in the present invention preferably is one which is obtained by synthesizing a compound represented by formula (2), described below, which is allowed to react with a divalent metal compound. These metal-containing compounds can be synthesized in accordance with methods, for example, as described in “Chelate Chemistry (5), Complex Chemistry Experiment Method [I], edited by Nankodo. Specific examples of a divalent metal compound usable in the present invention include nickel chloride, nickel acetate, magnesium chloride, calcium chloride, barium chloride, zinc chloride, zinc acetate, titanium (II) chloride, iron (II) chloride, copper (II) chloride, cobalt chloride, manganese (II) chloride, lead acetate, mercury chloride, and mercury acetate. Of the foregoing metal compounds, zinc chloride, zinc acetate, nickel chloride, nickel acetate, copper chloride and copper acetate are preferred in term of the color of a metal-containing compound itself and color of a chelated dye, and copper acetate is more preferred.

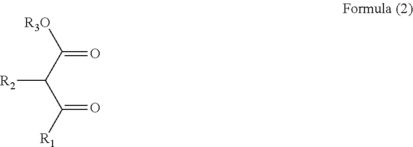

In the foregoing formula, R₁ is a hydrogen atom or a substituent. Examples of the substituent represented by R₁ include an alkyl group (methyl, ethyl, propyl, i-propyl, t-butyl, pentyl, hexyl, octyl, dodecyl, tridecyl, tetradecyl, pentadecyl, chlolomethyl, trifluoromethyl, trichloromethyl, tribromomethyl, pentafluoroethyl, methoxyethyl, etc.), a cycloalkyl group (cyclopentyl, cyclohexyl, etc.), an alkenyl group (vinyl, allyl, etc.), an alkynyl group (ethynyl, propargyl, etc.), aryl group (phenyl, naphthyl, p-nitrophenyl, p-fluorophenyl, p-methoxyphenyl, etc.), a heterocyclic group (furyl, thienyl, pyridyl, pyridazyl, pyrimidyl, pyrazyl, triazyl, imidazolyl, pyrazolyl, benzimidazolyl, thiazolyl, benzoxazolyl, quinazolyl, phthalazyl, pyrrolidyl, imidazolyl, morpholyl, oxazolydyl, etc.), an alkoxycarbonyl group (methoxycarbonyl, ethoxycarbonyl, buthoxycarbonyl, octyloxycarbonyl, dodecyloxycarbonyl, etc.), an aryloxycarbonyl group (phenyloxycarbonyl, naphthyloxycarbonyl, etc.), a sulfamoyl group (aminosulfonyl, methylaminosulfonyl, dimethylaminosulfonyl, butylaminosulfonyl, hexylaminosulfonyl, cyclohexylaminosulfonyl, octylaminosulfonyl, dodecylaminosulfonyl, phenylaminosulfonyl, naphthylaminosulfonyl, 2-pyridylaminosulfonyl, etc.), an acyl group (acetyl, ethylcarbonyl, propylcarbonyl, pentylcarbonyl, cyclohexylcarbonyl, octylcarbonyl, 2-ethylhexylcarbonyl, dodecylcarbonyl, benzoyl, naphthylcarbonyl, pyridylcarbonyl, etc.). a carbamoyl group (aminocarbonyl, methylaminocarbonyl, dimethylamiocarbonyl, propylaminocarbonyl, pentylaminocarbonyl, cyclohexylaminocarbonyl, octylaminocarbonyl, 2-ethylhexylaminocarbonyl, dodecylaminocarbonyl, phenylaminocarbonyl, naphthylaminocarbonyl, 2-pyridylaminocarbonyl, etc.), a sulfinyl group (methylsufinyl, ethylsuffinyl, butylsulfinyl, cyclohexylsulfinyl, 2-ethylhexylsulfinyl, dodecylsulfinyl, phenylsulfinyl, naphthylsulfinyl, 2-pridylsulfinyl, etc.), an alkylsulfonyl group (methylsulfonyl, ethylsulfonyl, butylsulfonyl, cyclohexylsulfonyl, 2-ethylhexylsulfonyl, dodecylsulfonyl, etc.), an arylsulfonyl group (phenylsulfonyl, naphthylsulfonyl, 2-pyridylsulfonyl, etc.) and cyano group.

R₁ is preferably a hydrogen atom, an alkyl group, an alkenyl group, an aryl group, a heterocyclic group, an alkoxycarbonyl group, an acyl group, a carbamoyl group, or cyano group; and more preferably, a hydrogen atom, an alkyl group, an aryl group, a heterocyclic group or cyano group. These substituents may be further substituted with other substituents.

R₂ is a hydrogen atom, an alkyl group, an alkenyl group, an alkynyl group, an aryl group, a heterocyclic group, an alkoxycarbonyl group, an aryloxycarbonyl group, a carbamoyl group, a sulfamoyl group, a sulfinyl group, an alkylsulfonyl group, an arylsulfonyl group or cyano group.

Specifically, examples of an alkyl group includes methyl, ethyl, propyl, i-propyl, t-butyl, pentyl, hexyl, octyl, dodecyl, tridecyl, tetradecyl, pentadecyl, chlolomethyl, trifluoromethyl, trichloromethyl, tribromomethyl, pentafluoroethyl, and methoxyethyl; examples of an alkenyl group include vinyl and allyl; examples of an alkynyl group include ethyl and propargyl; examples of aryl group include phenyl, naphthyl, p-nitrophenyl, p-fluorophenyl, and p-methoxyphenyl; examples of a heterocyclic group include furyl, thienyl, pyridyl, pyridazyl, pyrimidyl, pyrazyl, triazyl, imidazolyl, pyrazolyl, benzimidazolyl, thiazolyl, benzoxazolyl, quinazolyl, phthalazyl, pyrrolidyl, imidazolyl, morpholyl, and oxazolydyl; examples of alkoxycarbonyl group include methoxycarbonyl, ethoxycarbonyl, buthoxycarbonyl, octyloxycarbonyl, dodecyloxycarbonyl, examples of aryloxycarbonyl group include phenyloxycarbonyl and naphthyloxycarbonyl; examples of a carbamoyl group include aminocarbonyl, methylaminocarbonyl, dimethylamiocarbonyl, propylaminocarbonyl, pentylaminocarbonyl, cyclohexylaminocarbonyl, octylaminocarbonyl, 2-ethylhexylaminocarbonyl, dodecylaminocarbonyl, phenylaminocarbonyl, naphthylaminocarbonyl, 2-pyridylaminocarbonyl; examples of a sulfamoyl group include aminosulfonyl, methylaminosulfonyl, dimethylaminosulfonyl, butylaminosulfonyl, hexylaminosulfonyl, cyclohexylaminosulfonyl, octylaminosulfonyl, dodecylaminosulfonyl, phenylaminosulfonyl, naphthylaminosulfonyl, 2-pyridylaminosulfonyl; examples of a sulfinyl group include methylsufinyl, ethylsulfinyl, butylsulfinyl, cyclohexylsulfinyl, 2-ethylhexylsulfinyl, dodecylsulfinyl, phenylsulfinyl, naphthylsulfinyl, 2-pridylsulfinyl; examples of a sulfamoyl group (aminosulfonyl, methylaminosulfonyl, dimethylaminosulfonyl, butylaminosulfonyl, hexylaminosulfonyl, cyclohexylaminosulfonyl, octylaminosulfonyl, dodecylaminosulfonyl, phenylaminosulfonyl, naphthylaminosulfonyl, 2-pyridylaminosulfonyl; examples of a sulfinyl group include methylsulfinyl, ethylsulfinyl, butylsulfinyl, cyclohexylsulfinyl, 2-ethylhexylsulfinyl, dodecylsulfinyl, phenylsulfinyl, naphthylsulfonyl, and 2-pyridylsulfinyl; example of an alkylsulfonyl group include methylsulfonyl, ethylsulfonyl, butylsulfonyl, cyclohexylsulfonyl, 2-ethylhexylsulfonyl, and dodecylsulfonyl; and examples of an arylsulfonyl group include phenylsulfonyl, naphthylsulfonyl, and 2-pyridylsulfonyl.

R₂ is preferably a hydrogen atom, an alkyl group, an aryl group, a heterocyclic group, an alkoxycarbonyl group, or cyano group, and more preferably, a hydrogen atom, an alkyl group, an aryl group, a heterocyclic group, or cyano group. These substituents may be further substituted by other substituents.

R₃ is a hydrogen atom, an alkyl group, an alkenyl group, an aryl group or a heterocyclic group. Specific examples of an alkyl group include methyl, ethyl butyl, i-propyl, t-butyl, pentyl, hexyl, octyl, dodecyl, tridecyl, tetradecyl, pentadecyl; examples of an alkenyl group include vinyl and allyl; examples of an alkyl group include ethynyl and propargyl; examples of an aryl group include phenyl, naphthyl, p-nitrophenyl, p-fluorophenyl and p-methoxyphenyl; examples of a heterocyclic group include furyl, thienyl, pyridyl, pyridazyl, pyrazyl, pyrimidyl, triazyl, imidazolyl, pyrazolyl, thiazolyl, benzimidazolyl, benzoxazolyl, quinazolyl, phthalazyl, pyrrolidyl imidazolyl, morpholyl, and oxazolydyl.

R₃ is preferably an alkyl group or an aryl group. These alkyl group, alkenyl group, alkynyl group and aryl group may further be substituted with other substituents.

Further, R₁ and R₂, or R₂ and R₃ may combine with each other to form a 5- or 6-membered ring.

Specific examples of a metal-containing compound represented by the formula (1) are shown below, but are not limited to these.

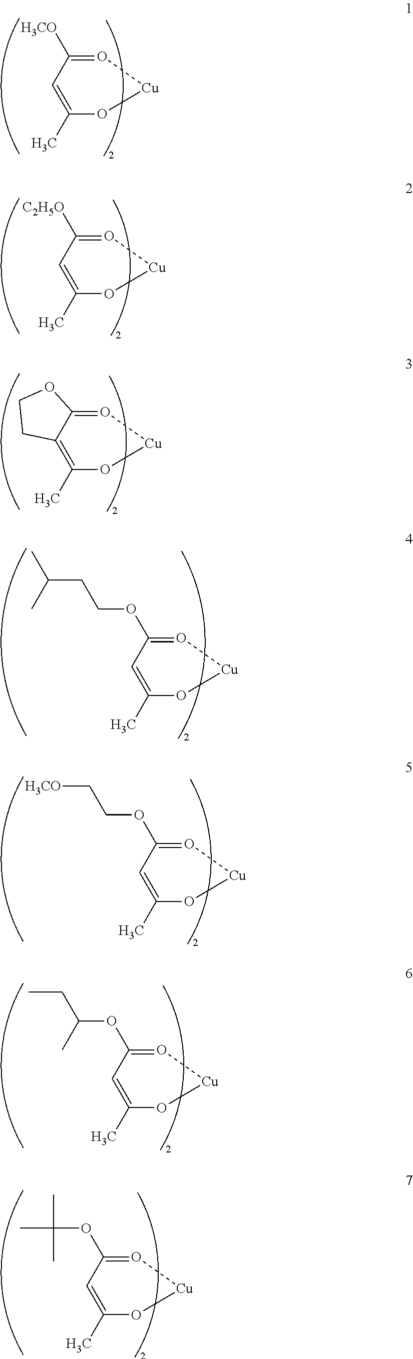

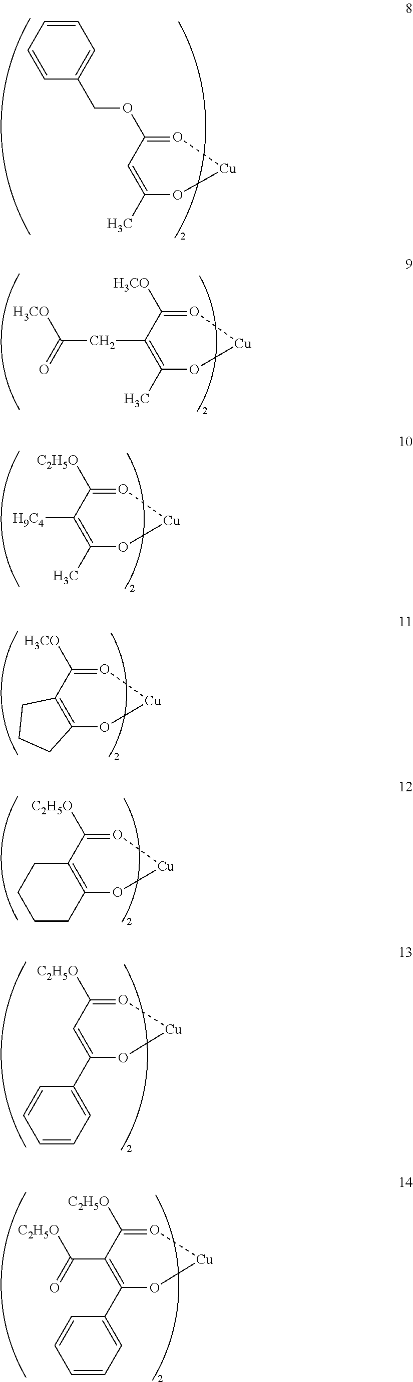

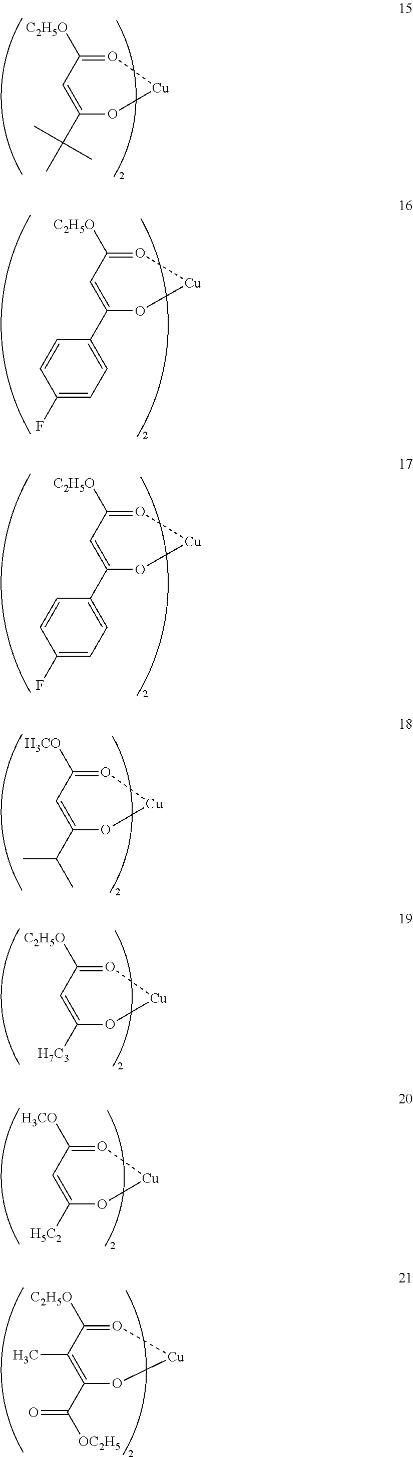

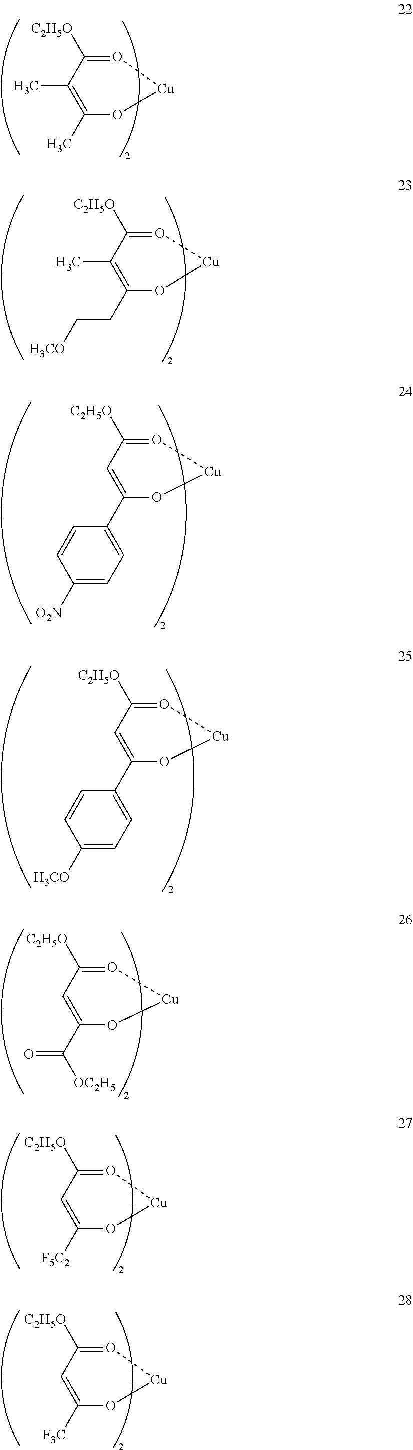

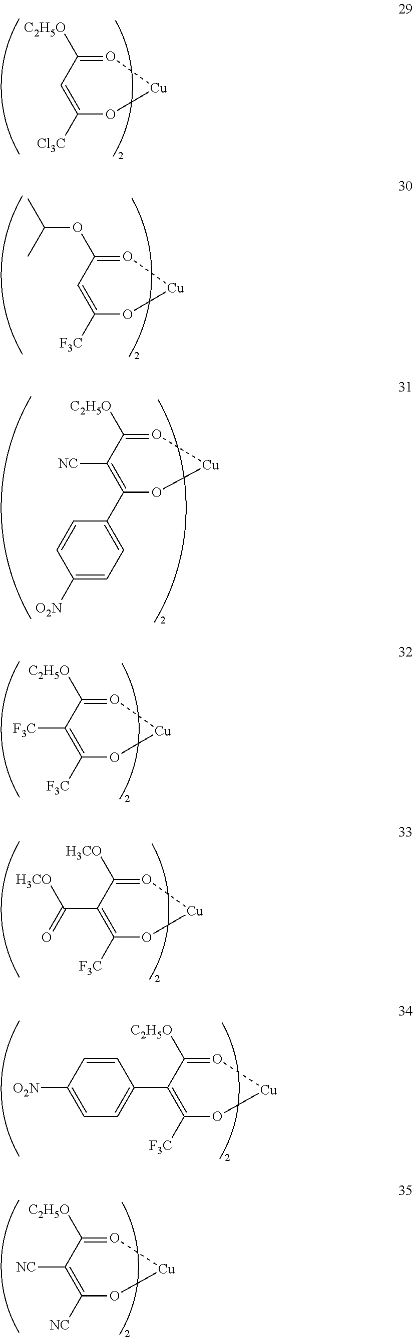

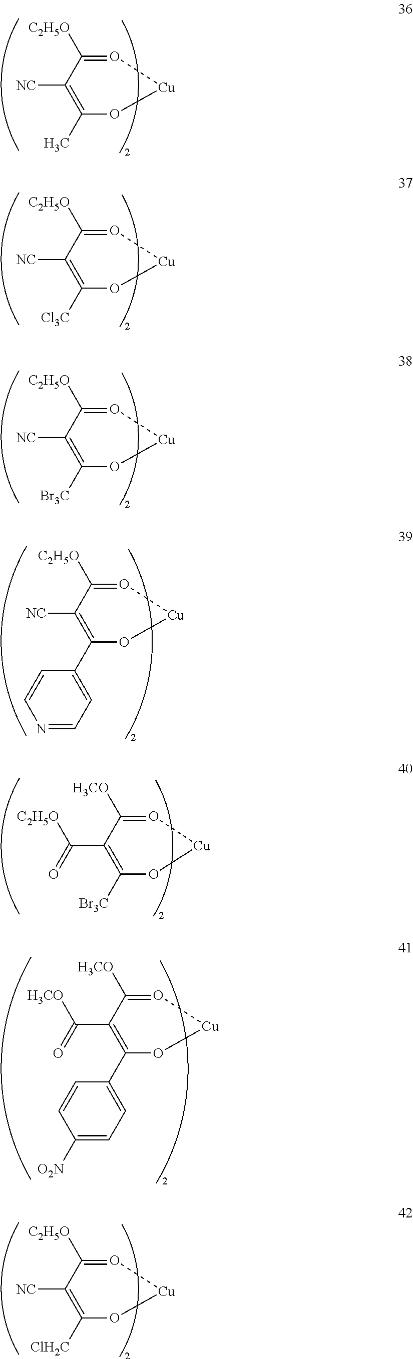

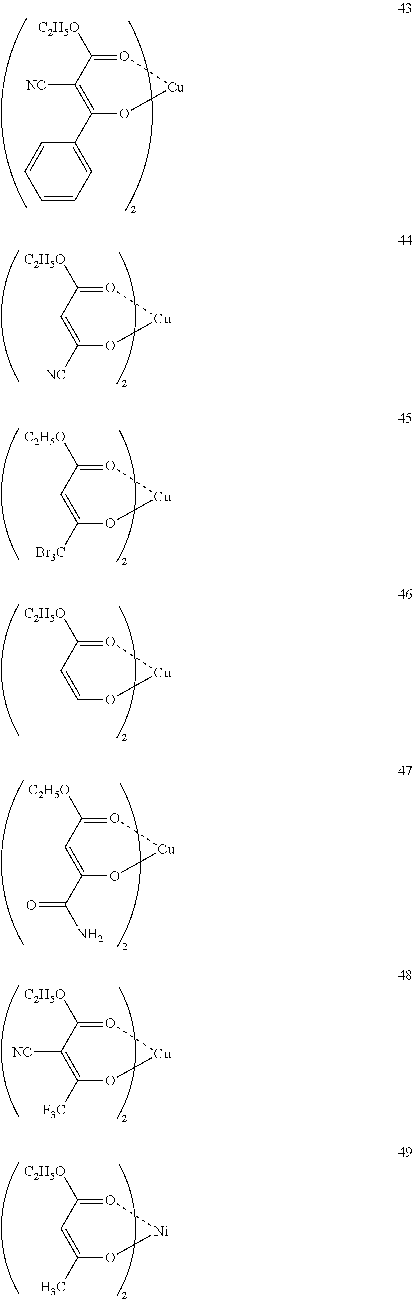

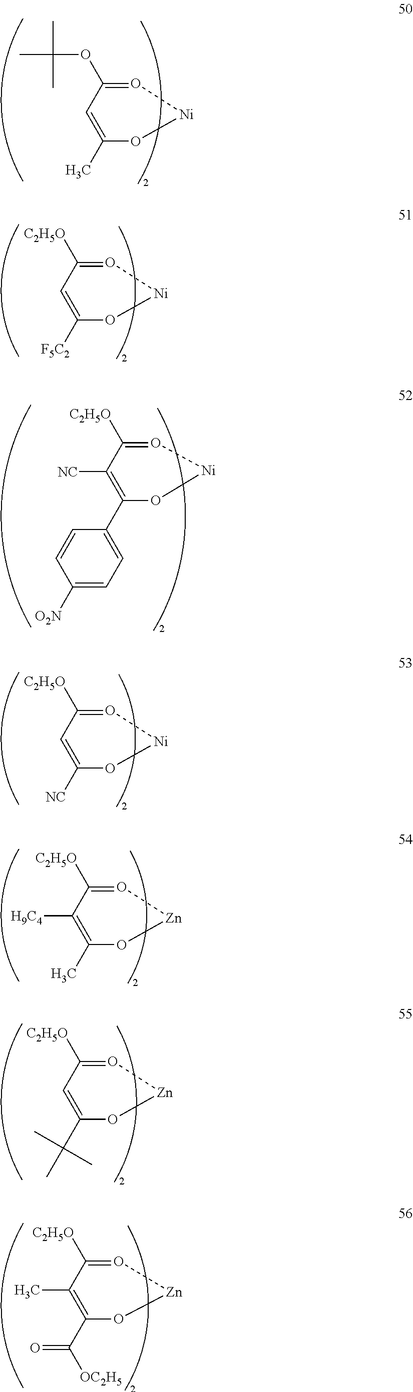

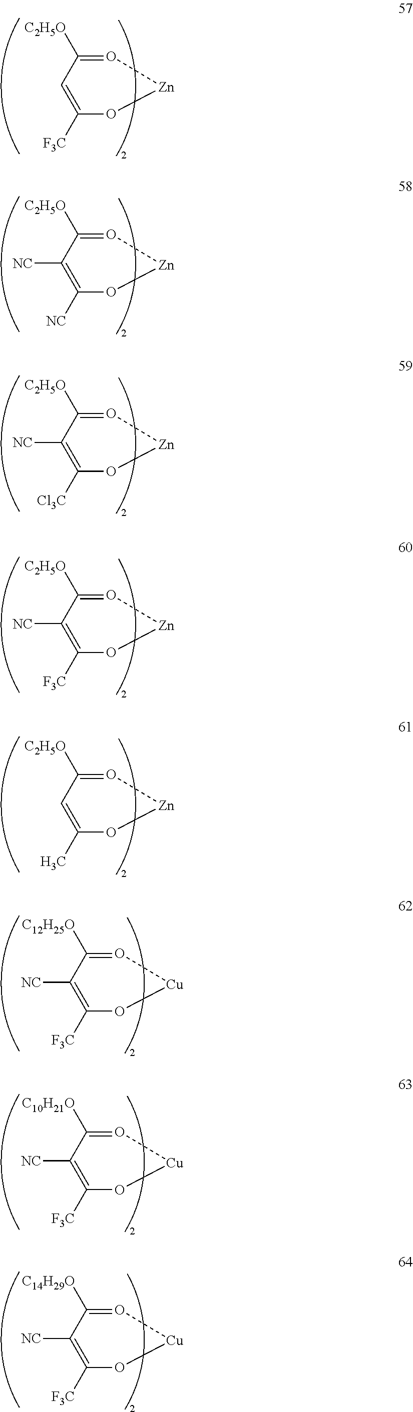

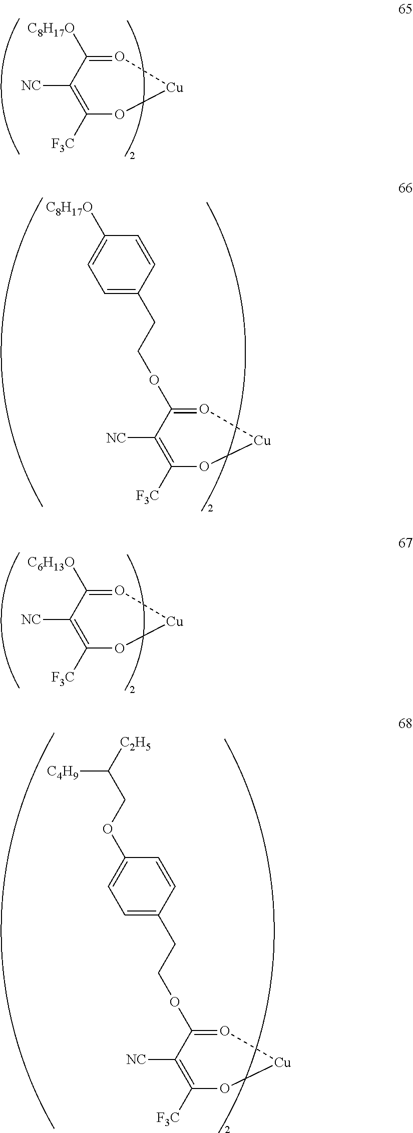

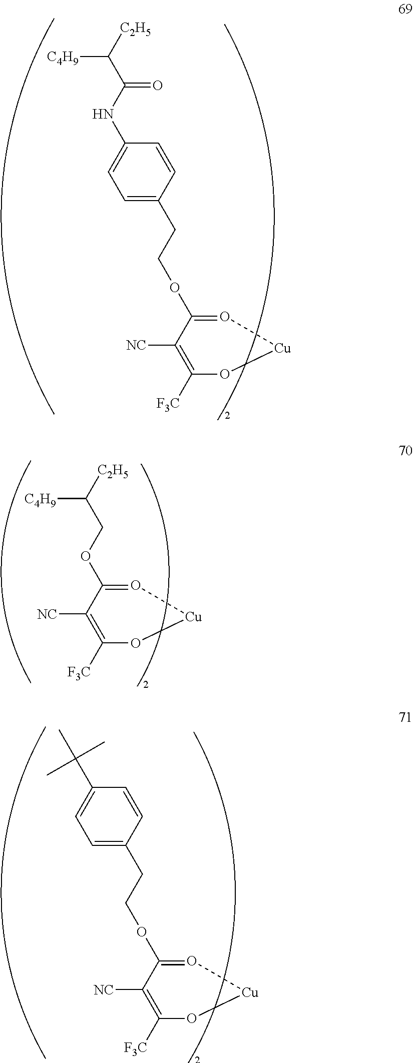

In cases when the metal-containing compound of the present invention is added to an electrophotographic toner, there is used at least a chelatable dye to form an image. Such a chelatable dye may be one which is capable of chelating with the metal-containing compound of the present invention, and preferably is a dye represented by the following formula (4):

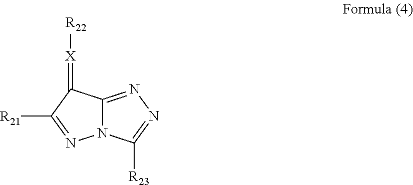

wherein R₂₁ is a hydrogen atom, a halogen atom or a substituent; R₂₂ is an aryl group or heterocyclic aryl group which may be substituted; X is a methane group or a nitrogen atom; R₂₃ represents the following formula (5) or (6), in which X′ is a carbon atom or nitrogen atom and Y is an atomic group forming a nitrogen-containing aromatic heterocycle together with —X′ and ═N—, W is an atomic group forming an aromatic carbon ring or an aromatic heterocycle, and R₂₄ is an alkyl group.

R₂₁ is preferably a substituent and examples of such a substituent include substituents which are the same as substituents capable of being substituted for R¹ in the foregoing formula (1). In cases when R₂₁ is a substituent, such a substituent is preferably an alkyl group, an aryl group or a heterocyclic aryl group. These may further be substituted by a substituent and examples of such a substituent include those which are the same as substituents capable of being substituted onto R₁ of the foregoing formula (1).

R₂₂ is an aryl group or a heteroaryl group and examples thereof include the same as substituents capable of being substituted onto R₁ of the foregoing formula (1).

Y is an atomic group capable of forming a nitrogen-containing aromatic heterocycle together with —X′═N—, and examples thereof include corresponding groups of the heteroaryl groups among substituents capable of being substituted onto R₁ of the formula (1).

W is an atomic group forming an aromatic carbon cycle or an aromatic heterocycle together with —C—C— and examples of the thus formed aromatic carbon ring or aromatic heterocycle include the same one as an aryl group (e.g., phenyl, naphthyl, p-nitrophenyl, p-fluorophenyl, p-methoxyphenyl, etc.) and a heteroaryl group (furyl, thienyl, pyridyl, pyridazyl, pyrimidyl, triazyl, etc.).

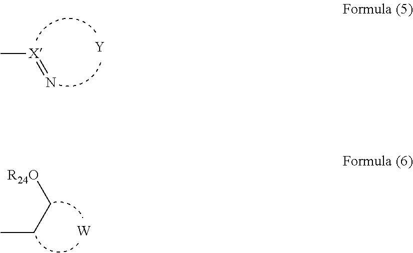

Dyes represented by the foregoing formula (4) can be synthesized according to the commonly known method. For instance, an azomethine dye of dyes represented by the formula (4) can be synthesized in accordance with an oxidation coupling method, as described in JP 63-113077 A, JP 03-275767 A and JP 04-089287 A.

Specific examples of a metal chelate type dye, represented by the formula (4) are shown below, but the present invention is by no means limited to these.

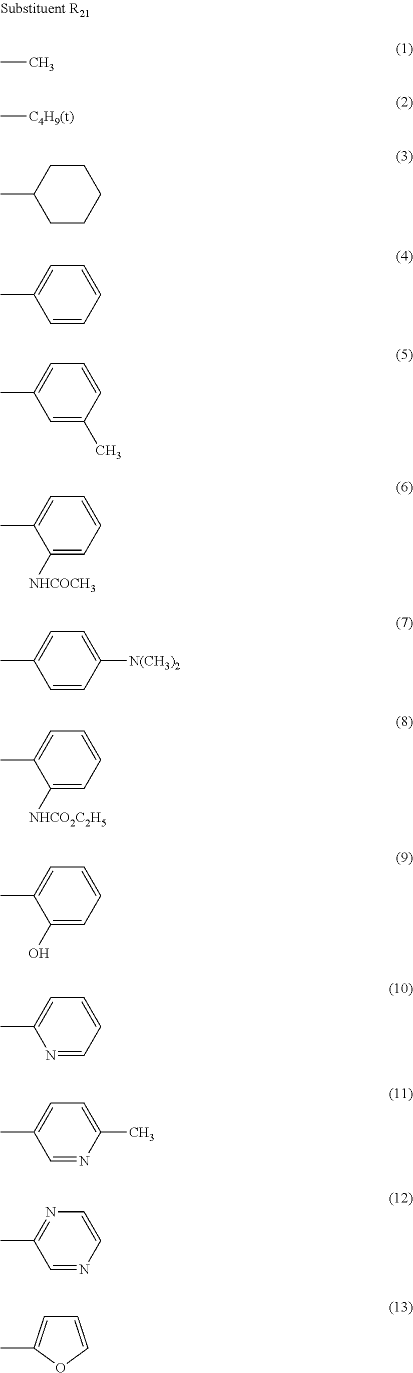

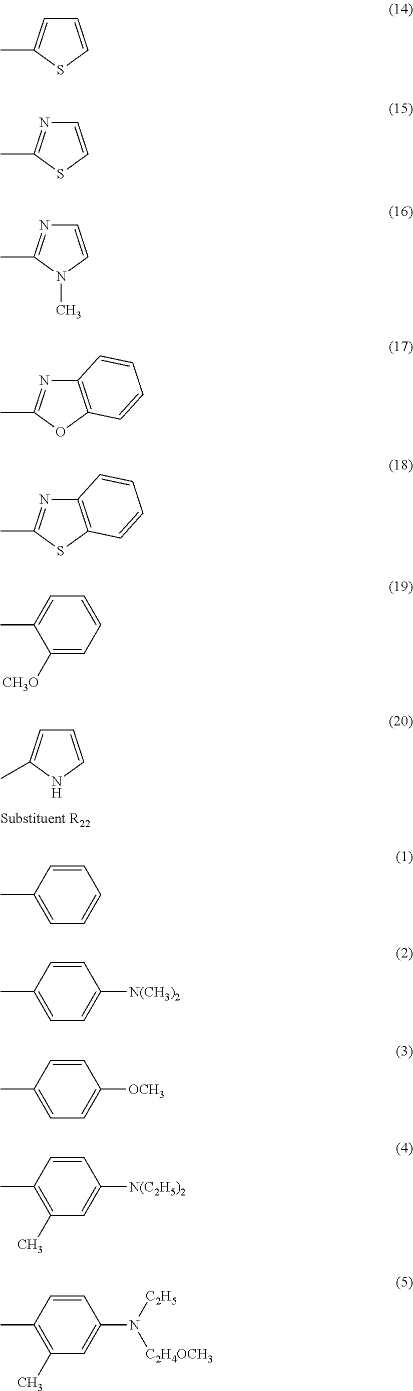

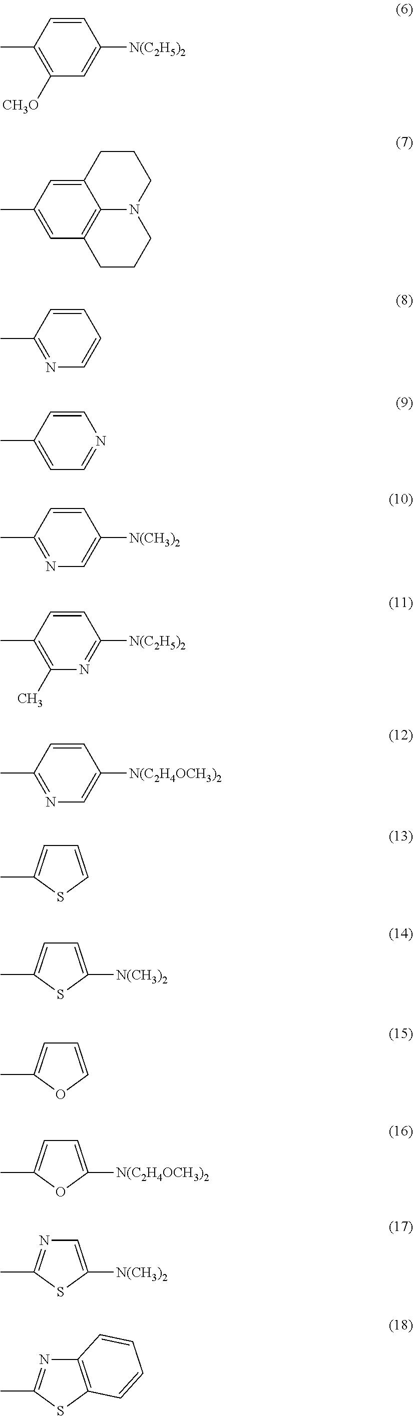

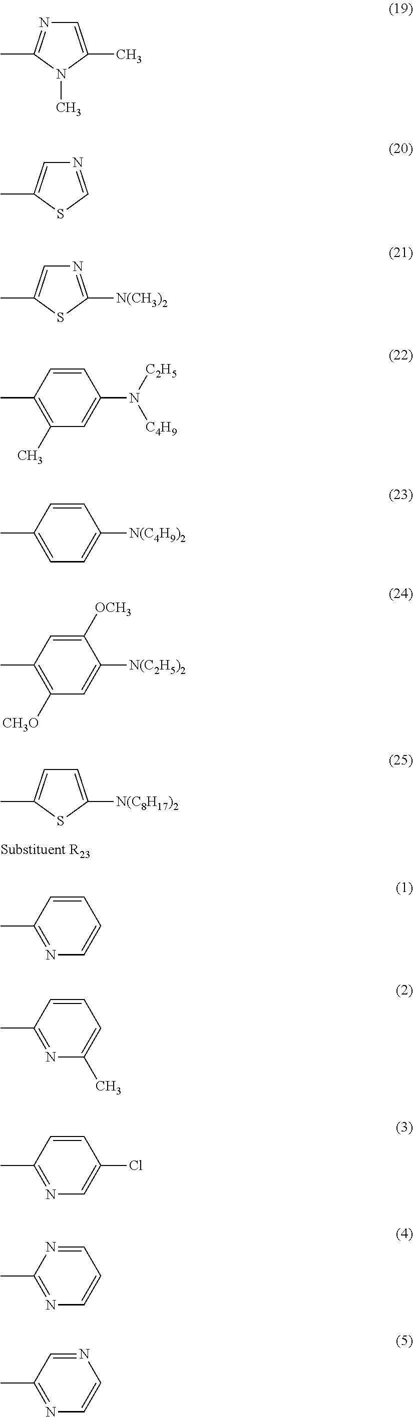

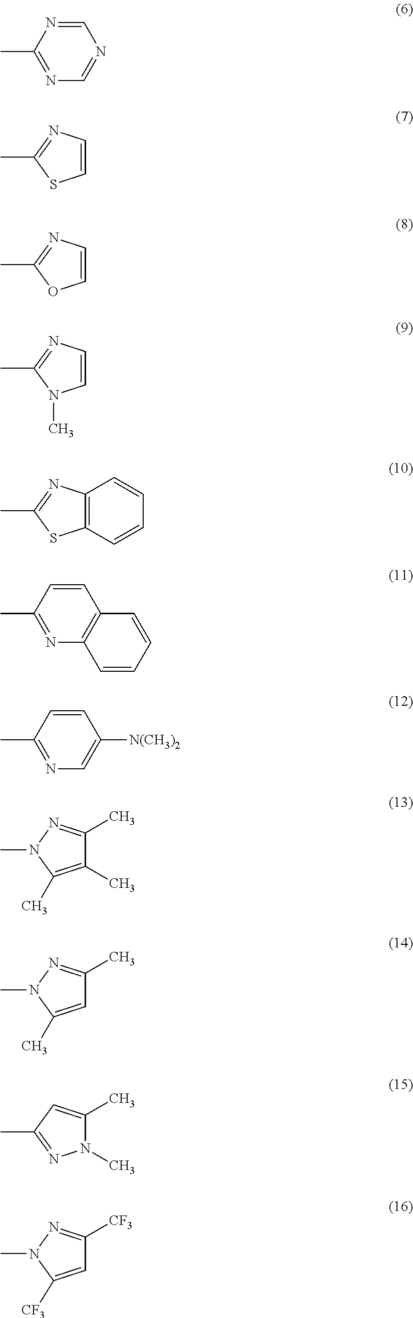

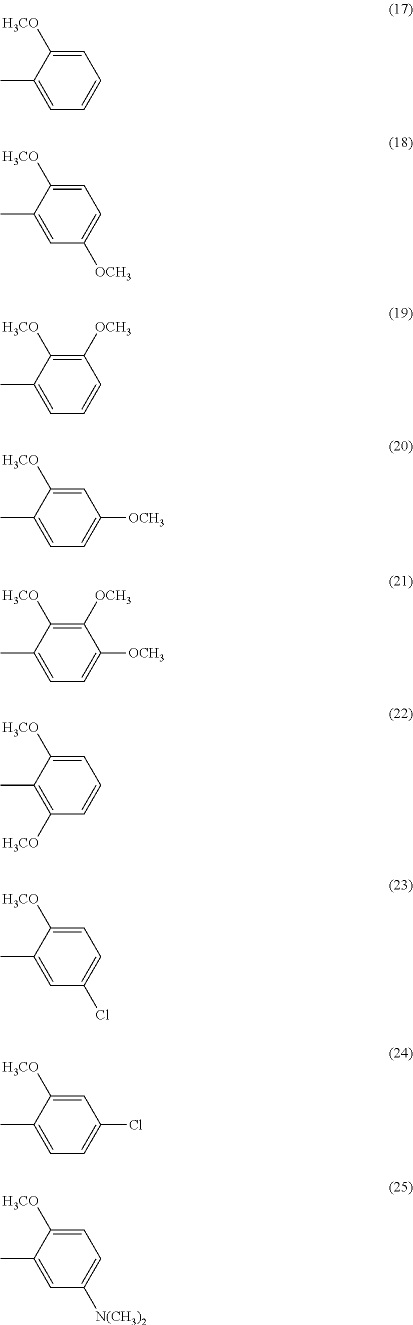

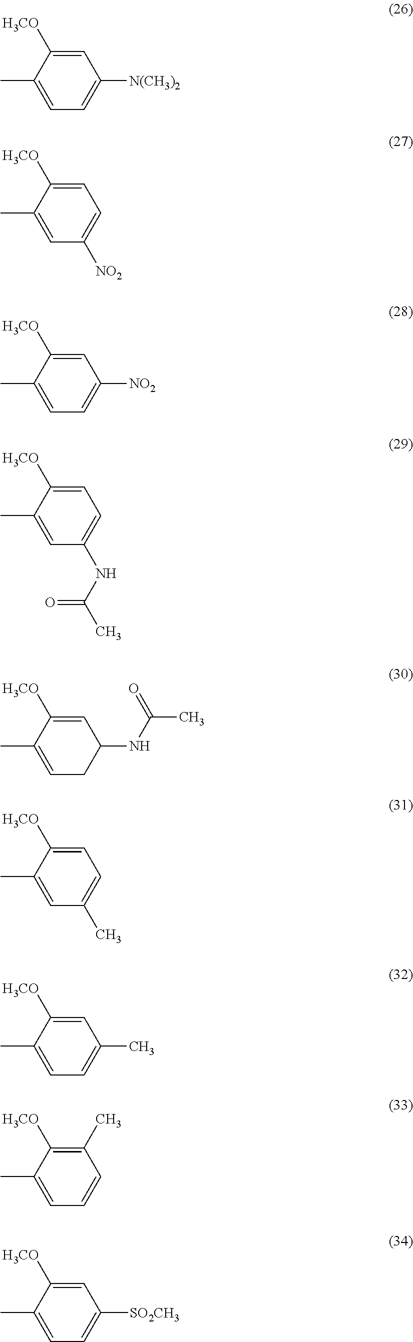

There are shown below combinations of a metal-containing compound of formula (1) and a metal chelate dye represented by the formula (4).

TABLE 1

| Dye | R₂₁ | R₂₂ | R₂₃ | X | Metal Containing Compound |
|---|---|---|---|---|---|
| R-1 | 1 | 3 | 1 | N | 36 |
| R-2 | 1 | 5 | 5 | N | 36 |
| R-3 | 1 | 4 | 3 | N | 36 |
| R-4 | 1 | 8 | 4 | N | 36 |
| R-5 | 1 | 10 | 9 | N | 36 |
| R-6 | 1 | 5 | 17 | CH | 36 |
| R-7 | 1 | 2 | 18 | CH | 36 |
| R-8 | 1 | 6 | 23 | CH | 36 |
| R-9 | 2 | 2 | 26 | N | 36 |
| R-10 | 2 | 8 | 27 | N | 36 |
| R-11 | 2 | 9 | 2 | N | 36 |
| R-12 | 2 | 1 | 5 | CH | 31 |
| R-13 | 2 | 4 | 8 | CH | 31 |
| R-14 | 2 | 13 | 29 | N | 31 |
| R-15 | 2 | 12 | 33 | N | 31 |
| R-16 | 2 | 18 | 15 | N | 31 |
| R-17 | 2 | 8 | 24 | N | 31 |
| R-18 | 2 | 10 | 28 | CH | 31 |
| R-19 | 3 | 5 | 29 | CH | 31 |
| R-20 | 3 | 2 | 33 | CH | 31 |
| R-21 | 3 | 18 | 13 | CH | 31 |
| R-22 | 3 | 6 | 15 | CH | 31 |
| R-23 | 3 | 17 | 12 | CH | 31 |
| R-24 | H | 5 | 4 | N | 35 |
| R-25 | H | 7 | 9 | N | 35 |
| R-26 | H | 6 | 17 | CH | 35 |
| R-27 | H | 10 | 18 | CH | 35 |
| R-28 | H | 12 | 23 | CH | 35 |
| R-29 | H | 7 | 27 | CH | 35 |
| R-30 | H | 4 | 2 | CH | 35 |
| R-31 | H | 8 | 5 | N | 35 |
| R-32 | H | 4 | 8 | N | 35 |
| R-33 | H | 10 | 29 | N | 35 |
| R-34 | H | 11 | 33 | N | 35 |
| R-35 | H | 3 | 15 | N | 37 |
| R-36 | 1 | 6 | 15 | N | 37 |
| R-37 | 1 | 15 | 24 | CH | 37 |
| R-38 | 1 | 14 | 28 | CH | 37 |
| R-39 | 1 | 20 | 29 | N | 37 |
| R-40 | 1 | 10 | 33 | N | 37 |
| R-41 | 1 | 12 | 13 | N | 37 |
| R-42 | 1 | 7 | 15 | N | 37 |
| R-43 | 1 | 4 | 12 | CH | 37 |
| R-44 | 1 | 20 | 36 | CH | 37 |
| R-45 | 1 | 8 | 39 | N | 37 |

### Cyan Toner:

A cyan toner used in the present invention can employ commonly known cyan toners, of which the most suitable one may be chosen in accordance with use or object of users.

Next, there will be described a cyan colorant which is preferable in the present invention. The cyan colorant refers to a dye giving rise to cyan color when an electrophotographic toner containing the said colorant is prepared and an image is formed by use thereof. The colorant may be a dye or a pigment. Cyan colorants used for a cyan toner include, for example, a copper phthalocyanine compound and its derivatives, such as a silicon phthalocyanine compound described in JP 2009-075520 A and its derivatives, an anthraquinone compound and a basic dye lake compound, but are not limited to these. Specifically, there are cited C. I. Pigment Blue 1, 7, 5, 15:1, 15:2, 15:3, 15:4, 60, 62 and 66, and silicon phthalocyanine compounds described in JP 2009-075520 A and their derivatives, which may be used singly. Of these, C. I. Pigment Blue 15:3 or silicon phthalocyanine are preferred.

### Combination Dye:

The dye of the present invention may be used in combination with another dye. Such a dye to be used together can employ generally known dyes, but an oil-soluble dye is preferred in the present invention. Such an oil-soluble dye is one which does not contain a water-solubilizing group such as a carboxylic acid group or a sulfonic acid group, and is soluble in an organic solvent and insoluble in water, but includes an oil-soluble dye obtained by allowing a water-soluble dye to react with a long chain base to form a salt. There is known, for example, a halochromic dye formed from an acid dye, direct dye or reactive dye and a long chain amine. Specific examples thereof include Valifast Yellow 4120, Valifast Yellow 3150, Valifast Yellow 3108, Valifast Yellow 2310N, Valifast Yellow 1101, Valifast Red 3320, Valifast Red 3304, Valifast Red 1306, Valifast Blue 2610, Valifast Blue 2606, Valifast Blue 1603, Oil Yellow GG-S, Oil Yellow 3G, Oil Yellow 129, Oil Yellow 107, Oil Yellow 105, Oil Scarlet 308, Oil Red RR, Oil Red OG, Oil Red 5B, Oil Pink 312, Oil Blue BOS, Oil Blue 613, Oil Blue 2N, Oil Black BY, Oil Black BS, Oil Black 860, Oil Black 5970, Oil Black 5906, and Oil Black 5905, made by Orient Kagaku Kogyo Co., Ltd.; Kayaset Yellow SF-G, Kayaset Yellow K-CL, Kayaset Yellow GN, Kayaset Yellow A-G, Kayaset Yellow 2G, Kayaset Red SF-4G, Kayaset Red K-BL, Kayaset Red A-BR, Kayaset Magenta 312, and Kayaset Blue K-FL, made by Nippon Kayaku Co., Ltd.; FS Yellow 1015, FS Magenta 1404, FS Cyan 1522, FS Blue 1504, C.I. Solvent Yellow 88, 83, 82, 79, 56, 29, 19, 16, 14, 04, 03, 02, 01, C.I. Solvent Red 84:1, C.I. Solvent Red 84, 218, 132, 73, 72, 51, 43, 27, 24, 18, 01, C.I. Solvent Blue 70, 67, 44, 40, 35, 11, 02, 01, C.I. Solvent Black 43, 70, 34, 29, 27, 22, 7, 3, C.I. Solvent Violet 3, C.I. Solvent Green 3 and 7, Plast Yellow DY35, Plast Red 8375, made by Arimoto Kagaku Kogyo Co., Ltd.; MS Yellow HD-180, MS Red G, MS, magenta HM-1450HMS Blue HM-1384, made by Mitsui Kagaku Co., Ltd.; Red 3001, ES Red 3002, ES Red 3003, TS Red 305, ES yellow 1001, ES Yellow 1002, TS Yellow 118, ES Orange 2001, ES Blue 600, TS Turq Blue 618, made by Sumitomo Kagaku Co., Ltd.; and MAC ROLEX Yellow 6g, Ceres Blue GNNEOPAN Yellow 075, Ceres Blue GN, MACROLEX Red Violet, made by Bayer Co.

There are usable disperse dyes as an oil-soluble dye and examples thereof include C.I. Disperse Yellow 5, 42, 54, 64, 79, 83, 83, 93, 99, 100, 119, 122, 124, 126, 160, 184:1, 186, 198, 204, 224 and 237; C.I. Disperse Orange 13, 29, 31:1, 33, 49, 54, 55, 66, 73, 118, 119 and 163; C.I. Disperse Red 54, 60, 72, 73, 86, 88, 91, 92, 93, 11, 126, 127, 134, 135, 143, 145, 152, 153, 154, 159, 164, 167:1, 177, 181, 204, 206, 207, 221, 239, 240, 258, 277, 278, 283, 311, 323, 343, 348, 356 and 362; C.I. Disperse Violet 33; C.I. Disperse Blue 56, 60, 73, 87, 113, 128, 143, 154, 158, 165, 165:1, 165:2, 176, 183, 185, 197, 198, 201, 214, 224, 225, 257, 266, 267, 287, 354, 358, 365 and 368, C.I. Disperse Green 6:1, and 6. There are also preferably used, as an oil-soluble dye, cyclic methylene compounds such as such as phenol, naphthols, pyrazolone, pyrazoltriazole; a coupler such as a ring-open methylene compound, p-diaminopyridines, an azomethine dye, and an indoaniline dye.

### Black Toner:

A black toner usable in the present invention may employ commonly known black toners, which can be suitably chosen in accordance with its use or purpose.

Next, there will be described black colorants usable in the present invention.

Specific examples of a black colorant include carbon black such as furnace black, channel black, acetylene black or lamp black, and magnetic powder such as magnetite or ferrite.

The primary particle size of colorant particles dispersed in a toner, which is variable according to their use, preferably is approximately from 10 to 200 nm, more preferably from 10 to 130 nm, and still more preferably from 10 to 90 nm. The content of a colorant preferably is from 1 to 10% by mass of a toner in terms of coloring capability and electrostatic-charging property, and more preferably from 2 to 8% by mass.

Addition to a toner can be conducted by any appropriate method and examples thereof include dissolution or impregnation in a binder resin, addition as a colorant solid dispersion differing from a binder resin dispersion, or a form of a mixture of a polymer and a high boiling solvent with the foregoing colorant solid dispersion. It is preferred to add a dispersion of solids exhibiting a weight average particle size of 10 nm to 1 μm in terms of stability, and a dispersion of solids exhibiting a weight average particle size of 10 to 90 nm is more preferred. A dispersion of monodisperse solids of 10 to 90 nm, in which light scattering is inhibited and no covering particle is present, is preferred in terms of color reproduction. Further, a dispersion of insoluble solids prevents diffusion or breeding, leading to enhanced light stability or heat resistance of the colorant. A solid dispersion mixed with a polymer or a high boiling solvent, which prevents coagulation and can effectively control a particle size, is appropriately added. Further, core/shell formation by coverage with an other polymer is also applicable to achieve enhanced production stability or storage stability. It is applicable to both polymerized toner and pulverized toner but application to a polymerized toner is more suitable in terms of workability of a toner and ease of addition of a colorant.

There will now be described a preferred preparation method of a solid dispersion in the invention.

In the present invention, a colorant solid dispersion can be obtained, for example, in such a liquid drying method that a dye is dissolved (or dispersed) in a water-immiscible organic solvent and dispersed in water, followed by removal of the organic solvent. In cases when a colorant is dispersible in a solid form, instead of the foregoing liquid drying method, a solid colorant may be dispersed in water containing a surfactant. Emulsifying machines are not limited but, for example, an ultrasonic dispersing machine or a high-speed stirring type dispersing machine is usable.

### Surfactant:

In the present invention, an emulsifying agent, a dispersing agent and a surface tension controlling agent are not specifically limited and any one of cationic, anionic, amphoteric and nonionic surfactants is usable.

Such an emulsifying agent or dispersing agent preferably is an anionic or nonionic surfactant. Both surfactants may be used in combination to meet various conditions. Examples of an anionic surfactant include a higher carboxylate such as sodium oleate, an alkylaryl sulfonate such as sodium dodecylbenzene sulfonate, an alkylsulfate ester salt such as sodium lauryl sulfate, a polyoxyethylene alkyl ether sulfuric acid ester salt such as polyoxyethylene lauryl ether sodium sulfate, polyoxyethylene alkyl aryl ether sulfuric acid ester salt such as polyoxyethylene nonyl phenyl ether sodium sulfate, and their derivatives such as sodium octylsulfosuccinate, sodium dioctylsulfosuccinate, or polyoxyethylene sodium laurylsulfosuccinate. Further, there are also cited, for example, dispersing agents Demol SNB, MS, N SSL, ST, and P (trade name, made by KAO Co., Ltd.). Water-soluble resins are also usable as a polymeric surfactant. Preferred examples of such a water-soluble resin include a styrene/acrylic acid/alkyl acrylate copolymer, styrene/maleic acid copolymer, styrene/methacrylic acid/alkyl acrylate copolymer, styrene/methacrylic acid copolymer, styrene/maleic acid half ester copolymer, vinylnaphthalene/acrylic acid copolymer and vinylnaphthalene/maleic acid copolymer. There is also cited, as a polymeric surfactant, JONCRYL of an acryl-styrene resin (made by JONSON Corp.). There is also usable a compound containing both of a monomer group and a surfactant component, known as a reactive emulsifying agent, which is low in capability of dissolving a dye and high in emulsifying capability. Examples of such a reactive emulsifying agent include LAMTER S-120, LAMTER S-120A, LAMTER S-180 and LAMTER S-180A (made by KAO Corp.); ELEMINOL JS-2 (made by Sanyo Chemical Industries Co.); NE series such as ADEKARIA SOAP NE-10, ADEKARIA SOAP NE-20, ADEKARIA SOAP-30 and SE-series such as ADEKARIA SOAP SE-10N, ADEKARIA SOAP SE-20N and ADEKARIA SOAP SE-30N (made by Asahi Denka Kogyo Co., Ltd.); AQUARON RN-series such as AQUARON RN-10, AQUARON RN-20, AQUARON RN-30 or AQUARON RN-59, AQUARON HS-series such as AQUARON HS-05, AQUARON HS-10, AQUARON HS-20, AQUARON HS-30, AQUARON BC-series (made by Daiich Kogyo Seiyaku Co., Ltd.), AQUARON BC series, AQUARON KH-05, AQUARON KHS-10, AQUARON HS-05, and AQUARON HS-10 (made by Daiich Kogyo Seiyaku Co., Ltd.); ADEKA RIA SOAP SE-series (made by Asahi Denka Kogyo Co., Ltd.) AQUARON HS-series (made by Daiich Kogyo Seiyaku Co., Ltd.), LATEML S-series (made by Sanyo Chemical Industries Co.); and ELEMINOL JS-series (made by Sanyo Chemical Industries Co.). Examples of a nonionic surfactant include polyoxyethylene alkyl ethers such as polyoxyethylene lauryl ether and polyoxyethylene stearyl ether, polyoxyethylene alkylphenyl ether such as polyoxyethylene nonylphenyl ether, sorbitan higher carboxylic acid esters such as sorbitan monolaurate, sorbitan monostearate and sorbitan trioleate; polyoxyethylene sorbitan higher carboxylic acid esters such as polyoxyethylene sorbitan monolaurate and polyoxyethylene monostearate; glycerin higher carboxylic acid esters such as oleic acid monoglyceride and stearic acid monoglyceride; and polyoxyethylene-polyoxypropylene block copolymer.

Amphoteric surfactants include a carboxybetaine type, sulfo-betain type, an aminocarxylate and imidazolinium betain.

Cationic surfactants include, for example, an aliphatic amine salt, an aliphatic quaternary ammonium salt, a pyridinium salt, and an imidazolinium salt.

These surfactants may be used singly or in a mixture of two or more of them and added in an amount of 0.001 to 1.0% by mass.

### Polymer:

In the present invention, when containing a polymer (resin) in a dispersion, the weight average molecular weight of the polymer is preferably less than 40,000, and more preferably not less than 500 and less than 40,000 in terms of capability of forming minute particles, superior dispersion stability and image transparency.

In the present invention, generally known resins are usable and examples thereof include a (meth)acrylate resin, a polyester resin, a polyamide resin, a polyimide resin, a polystyrene resin, a polyepoxy resin, a polyester resin, amino-type resin, a fluorinated resin, a phenol resin, a polyurethane resin, a polyethylene resin, a polyvinyl chloride resin, a polyvinyl alcohol resin, a polyether resin, poly(ether ketone) resin, poly(phenylene sulfide) resin, a polycarbonate resin and an aramid resin. Of these resins, a polymer containing an acetal group is preferred, of which polyvinyl butyral, polyvinyl acetal and a polymer obtained by radical polymerization of a vinyl monomer containing a polymerizable, ethylenically unsaturated double bond are preferred. Specific examples of a monomer of a vinyl monomer used for a radical-copolymer of a vinyl monomer include vinyl acetate, methyl acrylate, n-butyl acrylate, t-butyl acrylate, 2-ethylhexyl acrylate, isononyl acrylate, dodecyl acrylate, octadecyl acrylate, 2-phenoxyethyl acrylate, methyl methacrylate, ethyl methacrylate, n-butyl methacrylate, iso-butyl methacrylate, 2-ethylhexyl methacrylate, 2-hydroxyethyl methacrylate, dodecyl methacrylate, octadecyl methacrylate, cyclohexyl methacrylate, stearyl methacrylate, benzyl methacrylate, glycidyl methacrylate, phenyl methacrylate, styrene, α-methylstyrene, acrylonitrile and the like; soybean oil fatty acid-modified material of acetoacetoxyethyl methacrylate or glycidyl methacrylate (Blenmer G-FA, made by Nippon Yushi Co., Ltd.).

### Composition:

In the present invention, a solid dispersion contains a dye and optionally a polymer and a high boiling solvent. Such a polymer and a high boiling solvent are contained preferably in an amount of 30 to 70% by mass of the whole.

### Particle Size:

In the present invention, a colorant or a solid dye dispersion preferably exhibits a weight average particle size falling within a range of from 10 to 200 nm, more preferably from 10 to 130 nm, and still more preferably from 10 to 90 nm. When the weight average particle size falls within a range of less than 10 nm, the surface area per unit volume becomes extremely larger, stability of a solid dispersion easily becomes unstable, leading to deterioration in storage stability. Large particles of more than 130 nm result in a lowering of chroma of a toner per unit quantity of a coloring material.

Further, particle size distribution also affects chroma. Particle size distribution is defined in terms of CV value, as shown below.

A cumulative curve is determined with the proviso that the whole of particle size measurement values is defined to be 100% and the CV value is defined below:

CV value=(d84−d16)×100/(2×d50)

wherein d16, d50 and d84 are particle sizes when the cumulative curve reaches 16%, 50% and 84%, respectively. The CV value is preferably not more than 100, more preferably not more than 50, and still more preferably not more than 30.

The weight average particle size can be determined by a dynamic light scattering method, a laser diffraction method, a centrifugal decantation method, an FIT method, and an electric detector method. In the present invention is preferred determination by a dynamic light scattering method using an electrophoretic light scattering photometer (ELS-800, made by Otsuka Denshi Co., Ltd.).

### Toner:

In the present invention are usable commonly known charge controlling agents and offset inhibiting agents in addition to a binder resin, and a colorant or dye solid dispersion. A charge controlling agent is not specifically limited. There are usable, as negative-charge controlling agent used for a color toner, a colorless, white or hypochromic charge controlling agent which does not adversely affect color or translucence of a color toner; specific examples thereof include metal (such zinc or chromium) complexes of salicylic acid derivatives, a calixarene compound, an organic boron compound and a fluorine-containing quaternary ammonium salt compound. The foregoing salicylic acid metal complexes include, for example, those described in JP 53-127726 A and JP 62-145255 A, examples of a calixarene compound include those described in JP 02-201378 A, examples of an organic boron compound include those described in JP 02-221967 A, and examples of a fluorine-containing quaternary ammonium salt compound include those described in JP-03-001162 A. Such a charge controlling agent is used in an amount of 0.1 to 10 parts by mass, based on 100 parts by mass of a binder resin, and more preferably, 0.5 to 5.0 parts by mass.

An anti-offset agent is not specifically limited and specific examples thereof include a polyethylene wax, oxidation type polyethylene wax, polypropylene wax, oxidation type polypropylene wax, carnauba wax, sasol wax, rice wax, candelilla wax, jojoba wax and bees wax. Such a wax is added preferably in an amount of 0.5 to 5 parts by mass, based on 100 parts by mass of a binder resin, and more preferably 1 to 3 parts by mass. Addition of less than 0.5 part by mass is insufficiently effective and addition of more than 5 parts by mass results in a lowering of transparency or color reproduction.

In the present invention, a toner can be produced by using a binder resin, a dye solid dispersion and other desirable additives through a kneading/grinding method, a suspension polymerization method, an emulsion polymerization method or other methods. Of these production methods, the emulsion polymerization method is preferred in terms of production cost and production stability, while taking into account particle size reduction to achieve enhanced image quality.

Such an emulsion polymerization method is conducted in such a manner that a binder resin emulsion produced through emulsion polymerization is mixed with a dispersion of toner particle components such as a solid dye dispersion or the like and is allowed to slowly aggregate, while balancing, through pH control, the repulsion force of the formed particle surface with a cohesive force produced by addition of an electrolyte, and coalescence is performed with controlling the particle size and particle size distribution, while stirring with heating, and thereby, fusion of particles and particle shape control are performed to produce toner particles. Toner particles of the present invention preferably exhibit a volume-based median diameter of 4 to 10 μm, and more preferably, 6 to 9 μm in terms of high-precise image reproducibility.

In the present invention, there may be added a post-processing agent to achieve enhanced fluidity or cleaning property of toner particles, which is not specifically limited. Examples of such a post-processing agent include inorganic oxide particles such as silica particles, alumina particle and titania particles; inorganic stearic acid compound particles such as aluminum stearate particles and zinc stearate particles; and inorganic titanic acid compound particles such as strontium titanate and zinc titanate. These may be used singly or in combination with a dissimilar additive. These particles are desirably surface-treated with a silane coupling agent, a titanium coupling agent, a higher fatty acid, silicone oil or the like in terms of environment stability or heat storage stability, which are added preferably in an amount of 0.05 to 5 parts by mass, based on 100 parts by mass of a toner, and more preferably, 0.1 to 3 parts by mass.

The toner of the present invention may be mixed with a carrier to be used as a two-component developer or may be used as a single-component developer without using a carrier.

There are usable carriers, known as a carrier for a two-component developer and examples thereof include a carrier comprised of a particulate magnetic material such as iron or ferrite, a resin-coated carrier in which such a particulate magnetic material is coated with a resin, or a binder type carrier in which a powdery magnetic material is dispersed in a binder resin. Of these carriers, it is preferred to use a resin-coated carrier using, as a covering resin, a silicone resin, a copolymer resin (graft resin) of an organopolysiloxane and a vinyl monomer, or a polyester resin, in terms of toner spent, and a carrier coated with a resin obtained by allowing a copolymer resin of an organo-polysiloxane and a vinyl monomer to react with an isocyanate is preferred in terms of durability, environment resistant stability and spent resistance. It is necessary to use, as the vinyl monomer described above, a monomer containing a substituent capable of reacting with an isocyanate, such as a hydroxyl group. Further, the volume-based median diameter of a carrier is preferably from 20 to 100 μm, and more preferably, from 20 to 60 μm to achieve enhanced image quality and to prevent fogging.

### Binder Resin:

In the present invention, a binder resin contained in a toner preferably is a thermoplastic resin exhibiting enhanced adhesiveness to dispersed solids and a solvent-soluble one is specifically preferred. A curable resin forming a three-dimensional structure, a precursor of which is a solvent-soluble, is also usable. Resins which are generally used for a binder resin of a toner are usable without restriction. There are preferably used, for example, a styrene resin, an acryl resin such as an alkyl acrylate or an alkyl methacrylate, a styrene/acryl copolymer resin, a polyester resin, a silicone resin, an olefin resin, an amide resin, and an epoxy resin. Specifically, there is desired a resin exhibiting high transparency and melt characteristics of low viscosity and highly sharp melt property to achieve high transparency and enhanced color reproduction of superimposed images. Binder resins of such characteristics include, for example, a styrene resin, an acryl resin and a polyester resin.

A mixture of these resins may be used and there is also usable a composite resin in which an addition polymerization type of resin and a polycondensation type of resin are combined through acrylic acid or the like. Examples of such a composite resin include (i) one which is formed through transesterification between a polyester resin component and a vinyl resin component obtained by polymerization of a monomer component containing a carboxylate group such as an acrylate or methacrylate, (ii) one which is formed through transesterification between a polyester component and a vinyl resin component obtained by polymerization of a monomer component containing a carboxylic acid group such as an acrylic or methacrylic acid, and (iii) one which is formed through polymerization of a vinyl monomer in the presence of an unsaturated polyester resin component obtained by polymerization of an unsaturated monomer such as fumaric acid.

There is also usable a modified polymer obtained by allowing a functional group existing in a monomer or a terminal group of a resin to react with a compound which is active to the functional group.

The modified polymer, which includes a polymer having a site capable of reacting with a compound containing an active hydrogen group, is obtained by reacting with a compound containing an active hydrogen when forming particles in an aqueous medium. Such a polymer having a site capable of reacting with a compound containing an active hydrogen group preferably is a polyester prepolymer containing an isocyanate group, and the compound containing an active hydrogen group preferably is an amine, ketimine compound or oxazolone compound.

There is desirably used a binder resin exhibiting a number average molecular weight (Mn) of 3,000 to 6,000, preferably 3500 to 5500, a ratio of weight average molecular weight (Mw) to number average molecular weight, Mw/Mn of 2 to 6, preferably 2.5 to 5.5, a glass transition temperature of 50 to 70° C., preferably 55 to 70° C., and a softening point of 90 to 110° C., and preferably 90 to 105° C. There may be used two or more polymers which are different in number average molecular weight.

In cases of a binder resin exhibiting a number average molecular weight of less than 3,000, when a full-color solid image is bent, the image portion tends to peel, causing image defects (deterioration of bending fixability), and in cases of more than 6,000, heat fusibility at the time of fixing is lowered, leading to a lowering of fixing strength. A Mw/Mn of less than 2 easily causes high temperature offset and a Mw/Mn of more than 6 lowers the sharp melt characteristic at the time of fixing, leading to lowering of transparency of a toner and color mixing property at the time of full-color image formation. Further, a glass transition point of less than 50° C. results in insufficient heat resistance of a toner, easily causing coagulation of toner particles during storage, and when a glass transition point is more than 70° C., a toner becomes difficult to melt, leading to lowering of color mixing property in full-color image formation along with a lowering of fixability. Further, a softening temperature of lower than 90° C. easily causes high temperature offset and a softening point higher than 110° C. results in lowering of fixing strength, translucency, color mixing property, and glossiness of a full-color image.

### Image Forming Method:

Next, there will be described an image forming method by using a toner set of the present invention.

In the present invention, an image forming method is not specifically restricted. Examples thereof include a method of forming plural images on a photoreceptor, which are together transferred, and a method in which images formed on a photoreceptor are sequentially transferred onto a transfer belt, but are not specifically limited. However, a method of forming plural images on a photoreceptor, which are together transferred, is preferred.

In this method, a photoreceptor is uniformly electrostatic-charged and exposed to light in accordance with a first image, followed by first development to form a first toner image on the photoreceptor. Subsequently, the photoreceptor having formed the first image is uniformly electrostatic-charged and exposed to light in accordance with a second image, followed by second development to form a second toner image on the photoreceptor. Further, the photoreceptor having formed the first and second images is uniformly electrostatic-charged and exposed to light in accordance with a third image, followed by the third development to form a third toner image on the photoreceptor. Further, the photoreceptor having formed the first, second and third images is uniformly electrostatic-charged and exposed to light in accordance with a fourth image, followed by the fourth development to form a fourth toner image on the photoreceptor.

For example, the first development is conducted with a yellow toner, and the second, third and fourth developments are conducted with magenta, cyan and black toners, respectively to form a full-color toner image on the photoreceptor.

Thereafter, images formed on the photoreceptor are transferred together onto an image support such as paper and fixed to the image support to form an image.

This image forming method, in which the images formed on the photoreceptor are transferred together onto an image support such as paper, and differing from an intermediate transfer method, the number of times of transfer which possibly disrupts an image is only one time, resulting in enhanced image quality.

A method of developing a photoreceptor requires plural developments and preferably is a non-contact development. Further, a method in which an alternate electric field is applied in development is also preferable.

As described above, a development method in which superimposed color images are formed on an image forming body and collectively transferred, preferably is a non-contact development method.

The volume-based median diameter of a carrier used for a two-component developer is preferably from 15 to 100 μm, and more preferably from 25 to 60 μm. The volume-based median diameter of a carrier can be determined typically by using a laser diffraction type particle size distribution measurement apparatus (HELOS, made by SYMPATEC Co.).

A carrier preferably is one which is covered with a resin or a so-called resin dispersion type carrier in which magnetic particles are dispersed in a resin. The resin composition used for coating is not specifically limited but there may be used, for example, an olefin resin, a styrene resin, a styrene/acryl resin, a silicone resin, an ester resin or a fluorine-containing resin. A resin to constitute a resin dispersion type carrier is not specifically limited but can employ one known in the art and examples thereof include a styrene/acryl resin, a polyester resin, a fluororesin and a phenol resin.

A suitable fixing method usable in the present invention includes, for example, a contact heating system. Typical examples of such a contact heating system include a heated roll fixing method and a compressed heat-fixing method.

### Image:

In image formation performing development by using a toner set of the present invention, transfer and fixing, specifically in the steps of transfer and fixing, the toner of the present invention which has been transferred onto a transfer material adheres to the surface of paper without disintegrating the colorant or solid dye dispersion even after fixing.

In the present invention, as described above, a solid dispersion is dispersed within a particulate toner, so that the colorant or dye is not released (or not transferred) onto the toner particle surface, which can overcome problems in conventional toners such that (1) an electrostatic charge is low, (2) a difference in electrostatic charge between high temperature and high humidity, and low temperature and low humidity (environment dependency) is large, and (3) in cases when using various colorants, for example, cyan, magenta, yellow, and black colorants, the individual color toners are uneven in electrostatic charge. Further, when thermally fixed onto a transfer material, no transfer of colorant or dye to the outside of the dispersion of colorant or dye solids occurs, so that there does not occur sublimation of the dye or oil staining which is a problem arisen in a toner using a conventional dye.

### EXAMPLES

The embodiments of the present invention will be further described with reference to examples, but the present invention is by no means limited to these embodiments. In the examples, “part(s)” or “%” represents parts by mass or % by mass, unless otherwise noted.

### Example 1

There were prepared a pulverized toner and a polymerized toner by employing a production method of a pulverized toner or a production method of a polymerized toner.

### Toner Preparation Example 1 (Pulverization Method):

Into a Henschel mixer were added 100 parts by mass of a polyester (weight average molecular weight Mw: 20,000) as a condensation product of a bisphenol A/ethylene oxide adduct, 3 parts by mass of C.I. Pigment Red 146 as a colorant, 6 parts by mass pentaerythritol tetrastearate as a releasing agent, and 1 part by mass of benzilic acid borate as a charge controlling agent and mixed over 5 minutes at a circulation rate of 25 msec of a stirring blade.

Subsequently, the mixture was kneaded by a twin-screw extruder and then after being roughly ground by a hammer mill, the mixture was subjected to a pulverization treatment by a turbo-mill pulverizer (made by Turbo Kogyo Co., Ltd.) and was further subjected to a fine powder classifying treatment by using an airflow classifier employing the Coanda effect to obtain colored particles (1) exhibiting a volume-based median diameter of 5.5 μm.

Subsequently, to the thus obtained colored particles (1) were added 0.6 part by mass of a hexamethylsilazane-treated silica (average primary particle size of 12 nm) and 0.8 part by mass of n-octylsilane-treated titanium dioxide (average primary particle size of 24 nm), and subjected to an external additive treatment over 15 minutes by using a Henshell mixer (made by Mitsui Miike Kogyo Co., Ltd.) at a stirring blade circulation rate of 35 msec and a treatment temperature of 35° C., whereby a third electrophotographic toner 1 was prepared.

### Toner Preparation Example 2 (Pulverization Method):

### Preparation of Latex 1:

Into a 5000 ml separable flask fitted with a stirrer, a temperature sensor, a condenser and a nitrogen-introducing device was added a solution in which 7.08 g of an anionic surfactant (dodecylbenzene sulfonate, SDS) was dissolved in 2760 g of deionized water. The internal temperature was raised 80° C., while stirring at a rate of 230 rpm under a nitrogen gas stream. Meanwhile, 72.0 g of a releasing agent represented by the following formula (1) was added to the monomer composition of 115.1 g of styrene, 42.0 g of n-butyl acrylate and 10.9 g of methacrylic acid and dissolved with heating at 80° C. to prepare a monomer solution.

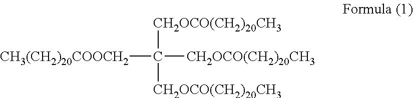

Further, the foregoing heated solution was dispersed by using a mechanical dispersing machine provided with a circulation path to prepare emulsified particles having a uniform dispersion particle size. Then, a solution in which 0.90 g of a polymerization initiator (potassium persulfate or denoted as KPS) was dissolved in 200 g of deionized water, was added thereto and stirred at 80° C. over 3 hours to prepare latex particles. Subsequently, a solution in which 8.00 g of the polymerization initiator (KPS) was dissolved in 240 ml of deionized water was added thereto and after 15 minutes, a mixed solution 3836 g of styrene, 140.0 g of n-butyl acrylate, 36.4 g of methacrylic acid and 13.7 g of t-dodecylmercaptan was dropwise added thereto over 120 minutes. After completing addition, the mixture was stirred with heating and then cooled to 40° C. to obtain latex particles. The thus obtained latex particles were denoted as latex 1.

### Preparation of Toner:

### Preparation of Colored Particle 1:

In 175 ml of deionized water was dissolved 12 g of sodium dodecylsulfate with stirring to obtain a solution. To this solution was gradually added 25 g of C. I. Pigment Red 146, as a colorant and dispersed by using a Clear-mix to prepare a dispersion. The thus prepare dispersion was measured by using an electrophoretic light scattering photometer (ELS-800, made by Otsuka Denshi Co., Ltd.) and it was proved that the weight average particle size was 110 nm. The thus prepare dispersion was denoted as a colorant dispersion 1.

Into a 5 liter four-neck flask fitted with a temperature sensor, a condenser, a nitrogen-introducing device and a stirrer were added 1250 g of the latex 1, 2000 ml of deionized water and the foregoing colorant dispersion 1 and stirred to prepare a solution. After controlling the temperature of the solution to 30° C., an aqueous 5 mol/l sodium hydroxide solution was added thereto and the pH was adjusted to 10.0. Subsequently, an aqueous solution in which 52.6 g of magnesium chloride hexahydrate was dissolved in 72 ml of deionized water, was added over 5 minutes with stirring at 30° C. Then, after allowed to stand for 1 minute, the solution was heated to a liquid temperature of 90° C. over 6 minutes (at a temperature rising rate of 10° C./min).

While maintaining such a state, particles sizes were measured by Coulter Counter TA-II and when the weight average particle size reached 6.5 μm, an aqueous solution in which 115 g of sodium chloride was dissolved in 700 ml of deionized water was added thereto to terminate the growth of particles and the liquid temperature was maintained at 90±2° C. with stirring over 6 hours to perform salting-out/fusion. Thereafter, the mixture was cooled to 30° C. at a rate of 6° C./min and after the pH was adjusted to 2.0 by addition of hydrochloric acid, stirring was stopped. Formed colored particles were filtered off and repeatedly washed with deionized water and then dried with 40° C. hot air to obtain colored particles. The thus obtained colored particles were denoted as colored particle 1.

Subsequently, hydrophobic silica (at a number average primary particle size of 12 nm and a hydrophobicity of 63) was added to the foregoing colored particle 1 and mixed by a Henschel mixer to prepare the third electrophotographic toner 2.

### Preparation of Toner:

The third electrophotographic toners 3 to 24 were each prepared in the same manner as the foregoing toner preparation example 1 or toner preparation example 2, except that the colorant was changed, as shown in Table 2.

Magenta toners 1 to 12 were each prepared in the same manner as the foregoing toner preparation example 1 or toner preparation example 2, except that a colorant was changed, as shown in Table 3.

### Preparation of Yellow Toner 1:

Yellow toner 1 was prepared in the same manner as the foregoing toner preparation example 2, except that the colorant was changed to C.I. Pigment Yellow 74.

### Preparation of Yellow Toner 2:

Yellow toner 2 was prepared in the same manner as the foregoing toner preparation example 2, except that the colorant was changed to C. I. Pigment Yellow 128.

### Preparation of Cyan Toner 1:

Cyan toner 1 was prepared in the same manner as the foregoing toner preparation example 2, except that the colorant was changed to C. I. Pigment Blue 15:3.

### Preparation of Black Toner 1:

Black toner 1 was prepared in the same manner as the foregoing toner preparation example 2, except that the colorant was changed to carbon black (MOGAL L, produced by Cabot Corp.).

The thus prepared toner dispersions were evaluated with respect to particle size on the evaluation basis, as described below. The results are shown Table 2.

### Particle Size of Dispersion:

A: Particle size of not more than 90 nm,

B: Particle size of not more than 130 nm and more than 90 nm,

C: Particle size of not more than 200 nm and more than 130 nm,

D: Particle size of more than 200.

### Image Formation:

A practical picture test was conducted by using a color copier (KL-2020, produced by Konica Minolta).

There was used a heated roll fixing system which is usually used as a fixing device. Specifically, a heating roller was constituted in which the surface of a cylindrical metal core (inner diameter of 40 mm, thickness of 1.0 mm and a total width of 310 mm), formed of an aluminum alloy and containing a heater in its central portion, was covered with a 120 μm thick tube of a tetrafluoroethylene/perfluoroalkyl vinyl ether copolymer (PFA); and a pressure roller was constituted in which the surface of a cylindrical metal core (inner diameter of 40 mm, thickness of 2.0 mm) formed of iron, was covered with a sponge-form silicone rubber exhibiting an Asker hardness of 48 and a thickness of 2 mm); and the heating roller and the pressure roller were brought into contact with each other by a load of 150 N to form a 5.8 mm wide nip.

Using this fixing device, the linear printing rate was set to 48 mm/sec. Further, there was used, as a cleaning mechanism of the fixing device, a web system which was impregnated with polydiphenylsilicone (exhibiting a viscosity of 10 Pa·s at 20° C.). The fixing temperature was controlled by the surface temperature of a heated roller (a set temperature of 175° C.). The coated weight of silicone oil was 0.1 mg/A4.

### Evaluation:

### Lightness of Third Electrophotographic Toner:

Using each of the third electrophotographic developers 1 to 24 and also using the foregoing image forming apparatus, there was prepared a monochromatic image exhibiting a density of 2.0 at the maximum peak wavelength on paper exhibiting an L* value of 90 and a C* value of 7.

The thus prepared monochromatic toner image was measured by using a spectrocolorimeter, CM-508d, made by Konica Minolta Corp. to determine the lightness on a CIELAB color space, which was evaluated based on the criteria described below:

A: Lightness of not less than 60 and not less than 65,

B: Lightness of not less than 50 and less than 60,

C: Lightness of less than 50.

### Hue Angle of Third Toner:

Concurrently with measurement of the foregoing electrophotographic toners, the hue angle on a CIELAB color space was determined by using a spectrocolorimeter CM-508d and evaluated based on the criteria described below:

A: Hue angle of not less than 0° and not more than 45°,

B: Hue angle of more than 45° and not more than 60°,

C: Hue angle of more than 60° and not more than 70°.

Evaluation results are shown in Table 2.

TABLE 2

| Developer | | Preparation Method | Dispersed | Hue | | |
|---|---|---|---|---|---|---|
| No. | Colorant | of Toner | Particle Size | Angle | Lightness | Remark |
| 1 | C.I. PR*¹ 146 | pulverization | — | B | B | Inv. |
| 2 | C.I. PR 146 | emulsion | B | B | B | Inv. |
| | | polymerization | | | | |
| 3 | C.I. PR 48:3 | pulverization | — | B | B | Inv. |
| 4 | C.I. PR 48:3 | emulsion | B | B | B | Inv. |
| | | polymerization | | | | |
| 5 | C.I. PR 209 | pulverization | — | B | B | Inv. |
| 6 | C.I. PR 209 | emulsion | A | B | B | Inv. |
| | | polymerization | | | | |
| 7 | C.I. PR 48:3 | pulverization | — | B | B | Inv. |
| 8 | C.I. PR 48:3 | emulsion | B | B | B | Inv. |
| | | polymerization | | | | |
| 9 | C.I. PR 209 | pulverization | — | B | B | Inv. |
| 10 | C.I. PR 209 | emulsion | B | B | B | Inv. |
| | | polymerization | | | | |
| 11 | R-1 | pulverization | — | A | A | Inv. |
| 12 | R-1 | emulsion | B | A | A | Inv. |
| | | polymerization | | | | |
| 13 | R-5 | pulverization | — | A | A | Inv. |
| 14 | R-5 | emulsion | B | A | A | Inv. |
| | | polymerization | | | | |
| 15 | R-10 | pulverization | — | A | A | Inv. |
| 16 | R-10 | emulsion | A | A | A | Inv. |
| | | polymerization | | | | |
| 17 | R-21 | pulverization | — | A | A | Inv. |
| 18 | R-21 | emulsion | B | A | A | Inv. |
| | | polymerization | | | | |
| 19 | R-35 | pulverization | — | A | A | Inv. |
| 20 | R-35 | emulsion | B | A | A | Inv. |
| | | polymerization | | | | |
| 21 | R-42 | pulverization | — | A | A | Inv. |
| 22 | R-42 | emulsion | A | A | A | Inv. |
| | | polymerization | | | | |
| 23 | C.I. PR*¹ 3 | pulverization | — | C | C | Comp. |
| 24 | C.I. PR 3 | emulsion | B | C | C | Comp. |
| | | polymerization | | | | |

*¹C.I. Pigment Red

In cases when using each of the third electrophotographic toners 1 to 22 related to the present invention, it was proved that the lightness, which was not less than 50, was excellent. Specifically when using each of the third electrophotographic toners 11 to 22, it was proved that the lightness was not less than 60 and specifically excellent color was achieved. On the contrary, when using the comparative third electrophotographic developer 23 or 24, it was proved that lightness was insufficient

### Lightness of Magenta Toner:

Using each of the magenta developers 1 to 12 and also using the foregoing image forming apparatus, there was prepared a monochromatic image exhibiting a density of 2.0 at the maximum peak wavelength on paper exhibiting an L* value of 90 and a C* value of 7.

The thus prepared monochromatic toner image was measured by using a spectrocolorimeter, CM-508d, made by Konica Minolta Corp. to determine the lightness on a CIELAB color space, which was evaluated based on the criteria described below:

A: Lightness of not less than 35 and not less than 50,

B: Lightness of more than 50.

Evaluation results are shown in Table 3.

TABLE 3

| Developer | | Preparation Method | Dispersed | | |
|---|---|---|---|---|---|
| No. | Colorant | of Toner | Particle Size | Lightness | Remark |
| 1 | C.I. PR*¹ 200 | pulverization | — | A | Inv. |
| 2 | C.I. PR 200 | emulsion polymerization | B | A | Inv. |
| 3 | C.I. PR 7 | pulverization | — | A | Inv. |
| 4 | C.I. PR 7 | emulsion polymerization | B | A | Inv. |
| 5 | C.I. PR 13 | pulverization | — | A | Inv. |
| 6 | C.I. PR 13 | emulsion polymerization | A | A | Inv. |
| 7 | C.I. PR 221 | pulverization | — | A | Inv. |
| 8 | C.I. PR 221 | emulsion polymerization | B | A | Inv. |
| 9 | C.I. PR 88 | pulverization | — | A | Inv. |
| 10 | C.I. PR 88 | emulsion polymerization | B | A | Inv. |
| 11 | C.I. PR 177 | pulverization | — | B | Comp. |
| 12 | C.I. PR 177 | emulsion polymerization | B | B | Comp. |

^{*1}C.I. Pigment Red

In cases when using each of the magenta developers 1 to 10 related to the present invention, it was proved that the lightness, which was not less than 35, was excellent

### Hue Difference Between Yellow and Magenta:

Using each of the yellow developers 1 and each of the magenta developers 1 to 12, and also using the foregoing image forming apparatus, there was prepared a monochromatic image exhibiting a density of 2.0 at the maximum peak wavelength on paper exhibiting an L* value of 90 and a C* value of 7. The combinations of the individual developers are shown in Table 4.

The thus prepared monochromatic toner image was measured by using a spectrocolorimeter, CM-508d, made by Konica Minolta Corp. to determine the hue angle on a CIELAB color space, which was evaluated based on the criteria described below:

### Difference in Hue Angle Between Yellow and Magenta:

A: A range of not less than 114° and less than 130°,

B: A range of less than 115° or more than 130°.

Evaluation results are shown in Table 4.

### Evaluation of Color Reproduction Range:

Using the third electrophotographic developers 1-24, the yellow developers 1-2, the magenta developers 1-12, the cyan developer 1 and the black developer 1, there were prepared reflection images (images on paper). The combinations of the individual developers are shown in Table 4. Evaluation was conducted at an adhered toner amount of 0.7±0.05 (mg/cm²).

The difference in hue angle between yellow and magenta, and the color reproduction area (gamut) were measured by using a single color of yellow/magenta/cyan and a solid image portion of each of R/G/B. Color reproduction areas were compared and relatively represented, based on the color area of Japan Color used for printing being 100, and evaluated in accordance with the following criteria:

### Color Reproduction Area:

A: Expansion of not less than 30%,

B: Expansion of 15 to 30%,

C: Expansion of 0 to 15%.

TABLE 4

| | | | | Hue Difference | Color | |
|---|---|---|---|---|---|---|
| Developer | | | | between Yellow | Reproduction | |
| Set | Yellow Developer | Magenta Developer | Third Electrophotographic Developer | and Magenta | Area | Remark |
| 1 | Yellow Developer 1 | Magenta Developer 1 | Third Electrophotographic Developer 3 | A | B | Inv. |
| 2 | Yellow Developer 1 | Magenta Developer 1 | Third Electrophotographic Developer 5 | A | B | Inv. |
| 3 | Yellow Developer 1 | Magenta Developer 1 | Third Electrophotographic Developer 8 | A | B | Inv. |
| 4 | Yellow Developer 1 | Magenta Developer 1 | Third Electrophotographic Developer 10 | A | B | Inv. |
| 5 | Yellow Developer 1 | Magenta Developer 4 | Third Electrophotographic Developer 2 | A | B | Inv. |
| 6 | Yellow Developer 1 | Magenta Developer 4 | Third Electrophotographic Developer 4 | A | B | Inv. |
| 7 | Yellow Developer 1 | Magenta Developer4 | Third Electrophotographic Developer 7 | A | B | Inv. |
| 8 | Yellow Developer 1 | Magenta Developer 4 | Third Electrophotographic Developer 9 | A | B | Inv. |
| 9 | Yellow Developer 1 | Magenta Developer 7 | Third Electrophotographic Developer 3 | A | B | Inv. |
| 10 | Yellow Developer 1 | Magenta Developer 7 | Third Electrophotographic Developer 4 | A | B | Inv. |
| 11 | Yellow Developer 1 | Magenta Developer 7 | Third Electrophotographic Developer 14 | A | B | Inv. |
| 12 | Yellow Developer 1 | Magenta Developer 7 | Third Electrophotographic Developer 15 | A | A | Inv. |
| 13 | Yellow Developer 2 | Magenta Developer 8 | Third Electrophotographic Developer 18 | A | A | Inv. |
| 14 | Yellow Developer 2 | Magenta Developer 8 | Third Electrophotographic Developer 22 | A | A | Inv. |
| 15 | Yellow Developer 2 | Magenta Developer 8 | Third Electrophotographic Developer 12 | A | A | Inv. |
| 16 | Yellow Developer 2 | Magenta Developer 8 | Third Electrophotographic Developer 15 | A | A | Inv. |
| 17 | Yellow Developer 2 | Magenta Developer 3 | Third Electrophotographic Developer 21 | A | A | Inv. |
| 18 | Yellow Developer 2 | Magenta Developer 3 | Third Electrophotographic Developer 20 | A | A | Inv. |
| 19 | Yellow Developer 2 | Magenta Developer 3 | Third Electrophotographic Developer 11 | A | A | Inv. |
| 20 | Yellow Developer 2 | Magenta Developer 3 | Third Electrophotographic Developer 13 | A | A | Inv. |
| 21 | Yellow Developer 2 | Magenta Developer 1 | Third Electrophotographic Developer 23 | A | C | Comp. |
| 22 | Yellow Developer 2 | Magenta Developer 11 | Third Electrophotographic Developer 5 | B | C | Comp. |

As is apparent from Table 4, it was proved that the combined use of the third electrophotographic developer related to the present invention and the combination of a yellow developer and a magenta developer, exhibiting a hue angle difference of 114 to 130° (degree) resulted in a greatly enlarged color reproduction area.

1. An electrophotographic toner set comprising at least a yellow toner, a magenta toner and a third electrophotographic toner, wherein, in a color specification system of a CIE LAB color space, a lightness L* of the magenta toner is within a range of 35-50, a lightness L* and a hue angle h of the third electrophotographic toner is within a range of 50-65 and 0-65°, respectively, and a difference in hue angle between a color represented by the yellow toner and a color represented by the magenta toner is within a range of 114-130°.

2. The electrophotographic toner set, as claimed in claim 1, wherein a hue angle h of the third electrophotographic toner is within a range of 0-45°.

3. The electrophotographic toner set, as claimed in claim 1, wherein the third electrophotographic toner contains a compound represented by the following formula (1): 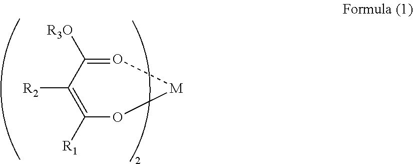
wherein M is a divalent metal ion, R₁ is a hydrogen atom or a substituent, R₂ is a hydrogen atom, an alkyl group, an alkenyl group, an alkynyl group, an aryl group, a heterocyclic group, an alkoxycarbonyl group, an aryloxycarbonyl group, a sulfamoyl group, a sulfinyl group, an alkylsulfonyl group, an arylsulfonyl group, or a cyano group, and R₃ is a hydrogen atom, an alkyl group, an alkenyl group, an alkynyl group, an aryl group or a heterocyclic group.
